(19) United States
(12) Patent Application Publication
(10) Pub. No.: US 2016/0221845 A1
(43) Pub. Date: Aug. 4, 2016

(54) MAGNETIC BALLAST CLARIFICATION DESIGNS AND APPLICATIONS

(71) Applicant: Steven Leslie Cort, Cary, NC (US)

(72) Inventor: Steven Leslie Cort, Cary, NC (US)

(21) Appl. No.: 14/612,635

(22) Filed: Feb. 3, 2015

(51) Int. Cl. C02F 1/48; B01D 21/01

(52) U.S. Cl. CPC C02F 1/488; B01D 21/01

(57) ABSTRACT

The present invention relates to new and novel magnetic collector designs and applications to improve present magnetic ballast clarification designs to remove solids from high flow rates of water.

### CROSS-REFERENCE TO RELATED APPLICATION

Provisional application Ser. No. 61/935,613 filed on Feb. 4, 2014.

### FIELD OF THE INVENTION

The present invention relates to the process of treating of water specifically to the use of magnetic material to enhance the clarification of water and to specific designs and methods to improve the efficiency of magnetic ballast clarification.

### BACKGROUND OF THE INVENTION

Clarification, that is the removal of suspended solids from water, is an important part of water treatment. There are many methods practiced for separating suspended solids from water such as gravity clarification, membrane filtration, and ballast clarification.

A series of improvements to these clarification technologies have been made to reduce their cost, reduce their size, and improve their operation. However one of the most cost effective and trouble free methods to clarify water quickly is ballast clarification, that is the use of dense materials in combination with flocculating polymers to speed the settling rates of suspended solids present in water.

Veolia perfected the use of sand as a ballast material to speed the clarification process with their Actiflo system. Actiflo uses a flocculating polymer to attach suspended solids in water to sand to form a dense floc that settles more rapidly. Settling is by gravity and is dependent on the density and particle size of the sand.

The major deficiency of the Actiflo design is it only relies on gravity for the removal of suspended solids so when there are rapid increases in hydraulic flow, there is no positive barrier to prevent the discharge of suspended solids. Also, the method used to remove and clean the sand ballast produces a dilute waste. Ballasted floc that settles to the bottom of the Actiflo clarifier has to be raked to the center of the clarifier so it can be pumped as dilute slurry to a hydrocyclone where the sand ballast is separated by centrifugal force to be reused. This process consumes a large amount of energy, has high capital cost, causes wear on critical pump parts, and because the sand slurry is dilute, the waste generated from Actiflo is also dilute.

It was then discovered that magnetite was a better ballast material than sand. Magnetite is denser than sand (twice as dense) and therefore settles more rapidly to make the clarification system smaller. Also magnetite is ferromagnetic (iron based material that is attracted to a magnet) so as described by the methods of this patent application, the magnetite can be removed from the system for cleaning by a magnetic device. This leaves much of the water out of the magnetite cleaning system and therefore produces a more concentrated waste.

The use of magnetite as a ballast material was first practiced over thirty years ago in Australia with the development of the Sirofloc technology. This technology did not use a flocculating polymer to attach suspended solids to the magnetic ballast, which in Sirofloc was magnetite, but rather used the electric charge of the magnetite to attract fine suspended solids of opposite charge to the magnetite. Sirofloc technology does not use a final magnetic collector but only gravity to remove the magnetite. The magnetite, after it adsorbs negatively charged colloidal sized suspended solids contained in the water, settles out of the water in a gravity clarifier. The magnetite is then pumped from the gravity clarifier to a cleaning system that uses caustic to change the charge of the magnetite so it can be reused in the clarification process to attract new negatively charged colloidal sized suspended solids. This process produced a large volume of caustic waste, could not handle water that contained high concentrations of suspended solids, and still relied on gravity settling. The Sirofloc technology has not been adapted to clarify wastewater.

The Comag system, developed by Cambridge Water Technologies, improved the Sirofloc technology by using a flocculating polymer and adding a final magnetic collector that uses a magnetic field produced by electromagnets to remove magnetic floc from the water. This modification made the system smaller and made it possible to treat water that contained a higher level of suspended solids, eliminated the use of magnetite cleaning chemicals, and initially eliminated the need for a gravity clarifier. However, the use of electromagnets in a final magnetic collector posed some significant disadvantages. First, electromagnets are expensive and use more electricity than permanent magnets. Second, the magnetic stainless steel wool that is used in the Comag magnetic collector is easily fouled and cannot process a high level of suspended solids in the water, much in the same way a sand filter cannot process a high level of suspended solids. When the concentration of suspended solids is high, the Comag final magnetic collector quickly fills with suspended solids and has to be frequently cleaned with a water and air backwash. This frequent backwashing produces a large quantity of waste, which is very dilute. Third, the final magnetic collector has to be de-energized for cleaning, which interrupts the treatment process. Therefore to correct some of these deficiencies, Cambridge Water Technologies added a gravity clarifier placed before the final magnetic collector to handle high solids loading and to reduce the backwashing frequency of the final collector. This addition of a gravity clarifier negated much of the initial size advantages of Comag.

The Cort U.S. Pat. No. 7,255,793 overcame many of the disadvantages of the Comag and Actiflo systems with the Magnetic Ballast Clarifier (MBC) system. The new MBC process that overcame the disadvantages of Actiflo and Comag is described in detail in the Cort US Pat. No. 7,255,793.

Cambridge Water Technologies then developed and promoted the use of magnetite to improve the settling characteristics of biosolids in a gravity clarifier. Woodard U.S. Pat. No. 7,695,623 describes how magnetite can be imbedded into a biological floc found in an activated sludge (AS) treatment system to increase the biofloc's weight and therefore improves its settling rate in a gravity clarifier. This improvement in floc settleability causes a two to threefold increase in gravity clarifier capacity, however, this approach to increase the settleability of a biofloc is not new and the Woodard U.S. Pat. No. 7,695,623 therefore only claims a collection of multiple physical devices working together to improve the performance of a gravity clarifier. The system claimed by Woodard U.S. Pat. No. 7,695,623 also has several disadvantages that are overcome by this patent application.

First, Woodard U.S. Pat. No. 7,695,623 describes a method that returns biofloc weighted with magnetite (Returned Activated Sludge (RAS)) to the aeration basin of an AS system. This approach increases the amount of energy needed to keep the weighted biofloc in suspension. Also, any magnetite that separates from the biofloc can settle to the bottom of the aeration basin potentially causing a major operating and cleanout problem.

Second, since in the Woodard U.S. Pat. No. 7,695,623 magnetite is added to the aeration basin, the magnetite has to be very fine so it can be kept in suspension. Also in laboratory tests conducted by Cort, course magnetite will not effectively imbed into a biofloc without the use of a flocculating polymer. However, a fine magnetite will not settle well in a gravity clarifier. This dilemma is eliminated since in this patent application magnetite is not added to the aeration basin; a more course magnetite can be used to enhance settling in the secondary gravity clarifier.

Third, Woodard U.S. Pat. No. 7,695,623 shows no inline mixing device to enhance the flocculation of biofloc, virgin magnetite and recycled magnetite with the addition of a flocculating polymer. FIG. 6 of Woodard U.S. Pat. No. 7,695,623 shows the location of an “impregnation” tank that combines virgin magnetite, recycled magnetite and biofloc, but the addition of a flocculating polymer to bind these solids together into a stable floc comes after the aeration tank and there is no in-line static mixer, hydraulic channel flocculator, or mixing tank to enhance flocculation before the gravity clarifier. Effective flocculation is best accomplished when flow turbulence provides enough energy to create a stable quality floc, but not so high that the flow turbulence causes destruction of the floc. This is difficult to achieve when the flow rate varies over a wide range. Flocculation is best accomplished under controlled conditions in a mixing tank, inline static mixer or hydraulic channel flocculator, which is accomplished by the design presented in this patent application.

Fourth, Woodard U.S. Pat. No. 7,695,623 does not have a way to concentrate the Waste Activated Sludge (WAS) and therefore reduce disposal costs. Biofloc weighted with magnetite settles to the bottom of the secondary gravity clarifier where it is removed and split into WAS and Returned Activated Sludge (RAS). The RAS, which contains magnetite is pumped back to the activated sludge basin and the WAS, which also is a dilute concentration of magnetite and biosolids is pumped as a dilute slurry to a magnetite cleaning and recovery system. The amount of water in dilute RAS is not much of a problem because it is sent back to the aeration basin and only increases pumping costs. However, RAS containing magnetite is a problem going back to the aeration basin because it results in greater energy use to keep this heavy floc in suspensions and operating and cleanout problems when magnetite settles to the bottom of the aeration basin. Another problem is the WAS and RAS contain magnetite which is abrasive to pumps and piping system. The approach taken in this patent application has a number of advantages over the approach described in Woodard U.S. Pat. No. 7,695,623. Following the art described in this patent application has many advantages over the art described in Woodard U.S. Pat. No. 7,695,623.

First, since the approach described in this patent application does not allow magnetite to enter the aeration basin, there is no increase in energy required to keep weighted biofloc in suspension and no resulting operating or cleanout problems associated with magnetite settling to the bottom of the aeration basin.

Second, since the approach described in this patent application can use a courser magnetite (between 40 and 200 microns) because it does not get into the aeration basin where it has to be kept suspended, biofloc weighted with a courser magnetite will settle more rapidly in the secondary gravity clarifier and thereby increase its capacity.

Third, since the approach described in this patent application contains a well-designed in-line mixer, a channel hydraulic flocculator, or in-tank mixer, flocculation is more efficient and better water clarity will be achieved.

Fourth, the Biomag magnetite cleaning process first shears the WAS to separate the magnetite from the other biosolids. This sheared dilute slurry then passes over a magnetic drum, which collects the separated magnetite and returns it back to the aeration basin. The dilute WAS not collected on the magnetic drum is disposed of, but because it is so dilute, it is more economic to first put it into a settling tank to concentrate the solids before it is dewatered. This patent application removes magnetic floc from the water by a magnetic collector that raises the magnetic floc out of the water leaving much of the excess water behind. This approach produces a much more concentrated WAS.

In summary, adding magnetite to the biological treatment process will significantly improve the settleability of bioflocs formed. However, in the Woodard U.S. Pat. No. 7,695,623, the methods described have shortcomings that are mostly overcome by this patent application. Specifically not adding magnetite to the aeration basin and controlling the amounts of weighted solids that can flow to the secondary gravity clarifier are two major advantages of this patent application. No other patent or information in the public domain describes the ideas contained in this patent application to improve clarification capacity in a way that reduces energy use, minimizes operating problems, and reduces the amount of waste generated. Applying the principles contained in this patent application will increase the treatment capacity of a municipal wastewater treatment plant two to threefold without increasing its footprint.

Being able to clarify water inline or with a small mix tank with the MBC allows it to be mounted inside or on top of an aeration basin or any biological or chemical treatment system, which has significant installation and operating benefits. Large flow rate systems such as municipal wastewater treatment systems have large transfer pipes between biological treatment and clarification. These pipes are normally installed underground and are often made of concrete. Retrofitting any treatment process that involves cutting into a large underground concrete pipe is costly and will cause a major interruption to system operation. The process presented in this patent application can be installed with no interruption to system operation and does not involve any major piping changes or penetrations.

The Actiflo, Biomag, and Comag processes all produce dilute wastes because of the way they have to clean their ballast material. Each process includes a gravity clarification step that allows weighted floc to settle to the bottom of a gravity clarifier. In order to recover and reuse the ballast material (microsand in the case of Actiflo and magnetite in the case of Biomag and Comag) dilute slurry of weighted floc is pumped from the bottom of the gravity clarifier to the ballast cleaning system. Since no process is used in these three technologies to remove water from these dilute slurries before the ballast material is cleaned and separated from the slurry, the resulting waste material is extremely dilute, in the order of less than 0.5 weight % dry solids. This is a major disadvantage of these technologies especially when waste solids have to be dewatered further before disposal. Increasing the concentration of dry solids in the waste product will reduce costs and benefit the environment. This patent application presents a novel way to reduce the amount of waste produced when magnetite is used as the ballast material.

As shown in FIG. 16a (prior art) of this patent application, the Biomag system relies on the secondary clarifier to collect MLSS weighted with magnetite. Not only does this approach cause potential problems with magnetite in the aeration basin, but also there are also potential problems with heavy solids causing damage to the sludge removal systems of the secondary clarifier. By adding a MBC into the biological treatment basin as shown in FIG. 16b of this patent application, neither does magnetite enter into the biological treatment basin increasing electrical usage to keep the magnetite in suspension nor does magnetite enter into the clarifier unless desired. This novel layout of placing a high rate clarification system inside a gravity clarifier is fully described in Cort U.S. Pat. No. 7,691,269. This allows the gravity clarifier to either operate more efficiently to separate solids or allows the gravity clarifier to be converted to a “biological reactor”. This patent application defines “biological reactor” so that it specifically covers MBBR biological reactors and biological contact reactors in addition to other aerobic and anaerobic biological reactors.

The MBC system described in Cort U.S. Pat. No. 7,255,793 uses magnetite as a ballast material in a way that is a significant improvement over the prior art. In the Cort U.S. Pat. No. 7,255,793, a plurality of magnetic disks is used to prevent magnetic floc from exiting the system. These magnetic disks are only partially submerged to prevent water from leaking past the rotating the shaft, and therefore only less than half of the magnets are capable of treating the water. Since magnetite is used as the ballast material and permanent magnets used instead of electromagnets, the system is smaller, uses less electricity, and produces less waste; yet future improvements were possible to increase the efficiency of the final magnetic collector that are now described in this patent application. This patent application among other things contains effective and novel ideas that enhance the performance of the MBC final magnetic collector. Specifically the positioning of the final magnetic collector and the flow path of water through the magnetic collector has significantly increased the capacity of the magnetic collector over five fold.

Filtration is an effective way to remove suspended solids from water but its disadvantages are it causes a significant pressure drop, is not capable of handling high solids levels, and is labor intensive and costly to replace disposable cartridges. This patent application describes a novel way for magnetite to be held in place by a magnetic field so it can act as a filter media. Therefore, if properly designed and operated, the magnetite filter will have a high capacity flow rate, will not foul, and is continuously cleaned, which minimizes labor and cartridge replacement costs. This is a significant advantage over a rotating disk filter that uses a cloth filter media to collect suspended solids that forms a filter cake, which creates a high pressure drop, is prone to fouling, and produces more waste from backwashing.

There are two primary methods for flocculating suspended solids with the use of a flocculating polymer. Each method has it specific advantages. One method is flocculation in a stirred tank. The mixing action provides enough motion and energy for particles to floc together. This method uses more energy, takes up more space, and does not provide completely uniform mixing conditions. However it can adjust to varying flow rates more effectively. The other primary method is inline mixing, which takes up less space, uses less energy and provides more uniform mixing conditions. However it does not adjust to varying flow rates effectively.

Heretofore, inline flocculation has not been incorporated into a magnetic ballast clarification system. The use of inline flocculation is effective in high flow rate applications where space is limited. This approach is advancement to the state of the art for magnetic clarification and is fully described in this patent application.

This patent application also describes novel production methods and materials to improve the cost effectiveness of MBC technology. Heretofore, these production methods and materials have not been used in the production of clarification technology that uses magnetite.

With the exception of membrane technology all other clarification systems operate at atmospheric pressure. Therefore if water is pumped into an atmospheric clarification process, the energy of the pressurized water in the pipeline is lost in some cases this is not an issue if the water only has to flow by gravity thereafter. However, if the water has to be pumped again, having a clarification system that operates under pressure is an advantage and a cost saver.

### BRIEF SUMMARY OF THE INVENTION

Aside from the preferred embodiment or embodiments disclosed below, this invention is capable of other embodiments and of being practiced or being carried out in various ways. Thus, it is to be understood that this invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer. It is therefore an objective of this invention to provide a system and method for enhancing the high rate clarification of water with new methods to use magnetic ballast materials effectively.

Furthermore, it is an objective of this invention to provide such a system and method, which is novel and cost effective.

Furthermore, it is an objective of this invention to provide such a system and method, which is reliable and simple to operate.

Furthermore, it an objective of this invention to provide such a system and method which is robust and replete with few operating problems.

Furthermore, it is an objective of this invention to provide such a system and method, which is effective in removing high concentrations of suspended solids from wastewater.

Furthermore, it is an objective of this invention to decrease the amount of waste generated by increasing the concentration of solids in the final waste stream, preferably a solid cake.

Furthermore, it is an objective of this invention to provide such a system and method, which reduces capital and operating costs.

Furthermore, it is an objective of this invention to combine water treatment processes into one unit to minimize space requirements.

Furthermore, it is an objective of this invention to retrofit existing water treatment systems to enhance performance and to reduce costs without increasing the footprint of the treatment system.

Furthermore, it is an objective of this invention to provide such a system and method, which will provide a high quality water effluent.

Furthermore, it is an objective of this invention to provide such a system and method, which improves the treatment efficiency of treating large flow applications because of a more efficient final magnetic collector.

Furthermore, it is an objective of this invention to provide such a system and method, which meets local, state and federal regulations for water and wastewater treatment.

The subject invention, however, in other embodiments, need not achieve all these objectives and the claims hereof should not be limited to structures or methods capable of achieving these objectives.

In previous MBC designs, the final magnetic collector is separate from the magnetite cleaning system. In the preferred embodiment of the Cort U.S. Pat. No. 7,255,793, the final collector is composed of a plurality of magnetic disks affixed to a rotating shaft but could also be a drum, which is less efficient. The magnetic disks are positioned in a floc tank and positioned between each disk is a scraper blade that removes the magnetite floc from the disks and causes the magnetite to fall back into the floc tank. The separate magnetite cleaning system is composed of one magnetic drum that removes dirty floc from the floc tank and deposits the floc into a horizontal shear tube or into a vertical shear tank that separates the magnetite from other suspended solids. The sheared solids discharge onto another magnetic drum that separates the magnetite from the non-magnetic solids. The non-magnetic solids leave the system as waste and the cleaned magnetite is returned to the floc tank for reuse. The novel design contained in this patent application (shown in FIGS. 1a and 1b) eliminates one magnetic drum from the magnetite cleaning system and now the design has been improved to only contain two magnetic devices rather than three. This is accomplished by making the final magnetic disk collector perform two functions. The first function is the magnetic disks prevent magnetic floc from leaving the MBC unit and the second function of the magnetic disks is to raise the magnetic floc out of the water so the magnetite can be cleaned and returned to the floc tank for reuse. Specifically as the magnetic disks rotate, the magnetic floc attached to magnetic disks contact a stationary scraper that is positioned towards the surface of the water in the floc tank. As the disks rotate, a scraper blade positioned between each rotating disk causes the magnetic floc to leave the disks and rise out of the water and flow into a magnetite shear device. This modification eliminated the need for one extra magnetic device but it did nothing to increase the capacity of the disks to treat water.

Heretofore, the state of the art was that magnetic disk collectors have been built so that the centerline of the disks is above the waterline to prevent submerging rotating bearings into water that contained magnetite, which is abrasive to bearings. Therefore, only less than half the disks were submerged and the capacity of the magnetic disk collector was reduced.

This limit to the capacity of the magnetic disk collector has been eliminated by the design described in this patent application.

Mounting the magnetic disk collector in a horizontal position mostly submerged with only a portion of the magnetic disk exposed above the water line increases the effective collection area of the magnetic disk and allows magnetite to be raised out of the water so it can be cleaned and reused with a minimum production of waste. The speed of the magnetic disks can be varied to control the amount of water that enters the magnetite cleaning system. At a high speed, more water is entrained with the magnetite and therefore the amount of waste is increased. At low speeds, much of the water is allowed to drain back into the MBC unit and therefore the amount of waste is decreased.

In prior art, the flow of water was always across the diameter of each magnetic disk. In this patent application, the flow of water is from the perimeter of the magnetic disk to its center and out through a center cutout in the magnetic disk and along the drive shaft that rotates the magnetic disks. This change increases the capacity of the magnetic disk as long as the center cut hole in the magnetic disk has enough capacity to handle the increased flow.

The reason that this new design for the magnetic disk has an increased capacity to collect magnetic particles is that the ability of a magnetic disk to capture and hold magnetic particle is a function of the velocity of the magnetic particle. The higher the velocity of the magnetic particle, the more difficult it is to capture and hold onto a magnet. Specifically, the velocity of water through the magnetic collector is the flow rate in cubic feet per second divided by the cross-sectional area in square feet. As the cross-sectional area is reduced, the velocity of water flow increases proportionally and therefore it becomes more difficult to collect magnetic particles with a magnet. Now in the case of previous designs, the flow velocity and therefore the capacity through the space between two magnetic disks was equal to less than its radius of the magnetic disk (because it was only half in the water) times the distance between magnetic disks. For example, if a magnetic disk is twenty (20) inches in diameter and there is one (1) inch gap between the magnetic disks, the effective cross-sectional area for flow between two disks is the radius of the disk times the distance between the disks. Therefore the effective cross-sectional area for flow between two disks is equal to about 9 square inches.

However, when water flows radially from the perimeter of the magnetic disk to the center of the magnetic disk, then the cross-sectional area is the circumference of the magnetic disk times the gap between the magnetic disks. Therefore, flow radially from the perimeter of a magnetic disk to its center and out through a center cutout in the magnetic disk, will have a lower velocity than if the flow is across the diameter of the magnetic disk. In comparison to the case where a 20-inch magnetic disk is only half submerged and flow is across the diameter of the magnetic disk, the velocity and therefore the flow capacity is proportional to the effective 9 square inches of cross-sectional area. When the magnetic disk is almost fully submerged and the flow is radially from the perimeter of the magnetic disk to the center of the magnetic disk, the cross-sectional area is equal to 3.14 times 16 inches (average circumference of the area containing magnets) times 1 inch, which is equal to 50.11 square inches. Therefore, when a magnetic disk is almost completely submerged and the flow is radially over the whole surface of the magnetic disk from its perimeter to its center cutout, the flow capacity is over five and a half times the flow capacity of a similar magnetic disk that is only half submerged having the flow of water across the diameter of the magnetic disk.

In summary, one aspect of this patent application describes a novel and cost effective magnetic collector (shown in FIGS. 1a and 1b) that is composed of a plurality of magnetic disks mounted horizontally to allow water to flow radially (from the perimeter to the center) over the surface of the magnetic disks contained in the magnetic collector and through a center cutout in the magnetic disk. The magnetic disks are mostly submerged to allow magnetite to be removed at a point above the water line so the magnetite can be cleaned with a minimum amount of waste produced.

The risen magnetic floc flows into a magnetite shear device that is composed of a series of abrasion resistant shear disks (see FIG. 11) affixed to a horizontal rotating shaft within a tube. The tube has two slits cut horizontally into the tube (see FIG. 12). The inlet slit has the largest opening of the two slits and is positioned at a higher elevation than the outlet slit. This allows the sheared floc to flow out of the shear device by gravity and with the help of the centrifugal forces caused by the rotating shear disks. While the mechanical scraping of the magnetic disks is effective and simple, the scrapers do wear out in time and their friction against the disks requires more energy to rotate the disks. An enhancement to mechanical scraping is to use high-pressure water to both remove the magnetic floc from the disks and in the process, shear the floc due to the high velocity of the water stream (see FIG. 15). This eliminates the need for scrapers that wear out, lowers the energy requirement to rotate the disks, and possibly eliminates the need for a mechanical shear device. However the downside is it adds more water, which dilutes the waste stream slightly. This downside can be eliminated if the wash water comes from the waste stream. Relatively clean water can be decanted from a tank that contains sludge from the magnetite cleaning process and then reused to remove magnetic floc from the magnetic disks.

The rotating shear disks have depressions cut or formed into its face to cause increased turbulence (see FIG. 11), which shears the magnetic floc and then because of the rotation of the shear disks forces the sheared magnetic floc to exit the shear device. The sheared slurry of magnetite and suspended solids exits the magnetite shear device and flows onto another magnetic device in the form of a rotating magnetic drum or a plurality of magnetic disks. As an alternative to mechanical floc-shearing, ultrasonic forces can break the connection of magnetite to the non-magnetic solids.

A magnetic drum following the magnetite shear device (see FIG. 3) is used to separate magnetic magnetite from non-magnetic solids contained in the sheared floc. The magnetite attaches to the magnetic drum and as the drum rotates, the magnetite is scraped off the magnetic drum and returned to the MBC floc tank for reuse. The non-magnetic solids do not attach to the magnetic drum and therefore flows underneath the magnetic drum and are collected in a trough and disposed.

Magnetic disks can also act as a magnetite filter (see FIGS. 7 and 8), and for this to happen, all of the permanent rare earth magnets are removed with the exception of the outer ring and this ring of rare earth magnets is replaced with less powerful permanent magnets such as ferrite magnets.

The Ferrite magnets are just strong enough to hold magnetite in place to form a bridge between the outer rings of magnets. This bridge of magnetite acts like a solid filter barrier but since this filter barrier is not strongly held by the ferrite magnets so more powerful rare earth magnets can easily remove the barrier.

The magnetite bridge between opposing magnets in each magnetic disk that has now filtered out suspended solids from the flowing stream of water is remove magnetically by more powerful rare earth magnets mounted in a revolving drum that is in contact with the perimeter of the magnetic disk.

When the magnetite and suspended solids move away from the force of the weaker ferrite magnets and on to the more powerful rare earth magnets contained in the rotating drum, the magnetite is cleaned with scrapers and cleaning sprays to separate the suspended solids from the magnetite so the cleaned magnetite can redeposit back onto the magnetic disks containing the less powerful ferrite magnets and the magnetite filtration bridge is then re-established.

The production of magnetic drums to separate magnetite from non-magnetic solids requires the nesting of permanent magnets inside a hollow plastic duct, preferably a commercially available PVC duct. Nesting the magnets close together increases the magnetic field strength and therefore the collection capacity of the magnetic drum. However, placing unrestrained magnets in close proximity to each other will cause them to clump together and make it impossible to place the magnets inside the hollow PVC duct in contact with the inner surface of the PVC duct. In order to prevent this from happening, as iron metal sheet (see FIG. 9) is wrapped around the outside of the PVC plastic drum to restrain the magnets against the inner surface of the PVC plastic drum. Therefore, when the magnets are nested inside the drum, they are held in place by the attraction to the iron metal sheet, which prevents a chain reaction between the magnets causing them to all to clump together. This exterior iron metal sheet holds the magnets in place until they are bonded in place with a suitable adhesive and protective plastic liquid coating to prevent corrosion. An alternative method for placing magnets inside a hollow PVC duct is to first place the magnets into a holder that holds the magnets against the inner surface of the PVC duct. These holders can then be placed individually into the PVC duct and held against the inner surface of the PVC duct without them coming into contact with each other. However this approach makes it necessary to anchor the magnets and holder against the inside of the PVC duct.

An important part of the MBC is the floc tank that is used to cause suspended solids to be attached to magnetite with the use of a flocculating polymer. This patent application shows the novel flow of water into the MBC system to quickly come into contact with cleaned magnetite coming from the magnetic drum (see FIGS. 1 and 2). Water containing suspended solids enters the MBC floc tank in close proximity to the discharge of cleaned magnetite from the magnetic drum. This causes the magnetite to rapidly and completely mix with the suspended solids in the water and with the use of a flocculating polymer a magnetic floc is rapidly formed.

A baffle is placed in the floc tank that prevents the short-circuiting of floc through the floc tank (see FIGS. 1 and 2). A draft tube comprised of a hollow cylinder placed vertically around the floc mixer shaft and blade will accomplish this same task. Therefore the mixing time is increased before the magnetic floc reaches the final magnetic collector.

Mounting the final magnetic collector horizontally inside the floc tank requires a rotating seal between the outboard magnetic disk closest to the wall of the floc tank and the wall of the floc tank. This is a potential source of leakage of magnetic floc from the MBC system. To prevent this from happening, either the permanent magnets are placed on the perimeter of the magnetic disk closest to the discharge from the floc tank to form a magnetic seal, which prevents magnetic particles passing through the rotating seal or permanent magnets are placed inside the rotating seal. The rotating seal is made of abrasion plastic with one half of the seal attached to the wall of the floc tank (fixed seal) and the other half of the seal attached to adjacent rotating magnetic disk (rotating seal). Another alternative is to place permanent magnets in the fixed seal part that is affixed to the tank wall. Therefore as magnetite enters the space between the fixed seal and the rotating seal, the magnetite is held in place by the permanent magnets causing a seal between the two seal faces. A preferred approach is to place the outboard disk closest to the tank wall against the tank wall so the magnets in the disk will collect any magnetite that is attempting to exist the floc tank (see FIG. 7). Using a thin sheet of abrasive resistant plastic against the tank wall can prevent wear of the tank wall.

The original design of the magnetic disks was three circular disks of PVC cemented together with permanent magnets contained in the inner PVC disk. In this inner disk of PVC, one-inch diameter holes were punched in strategic locations to contain the permanent magnets. This laminated construction can delaminate and allow water to come into contact with the permanent magnets causing rusting. Also, there are limits to the size of disks that can be constructed with this manufacturing method due to the warping of the disks when they are too large. A preferred construction method is to cast the disks with a thermosetting plastic such as polyurethane. This eliminates the possibility of disk delamination and allows stiffeners to be placed within the magnetic disks, which allows a larger size disk to be fabricated. Disks can also be injection molded using thermoplastics.

One factor that limits the capacity of the MBC is the residence time in the floc tank. Laboratory tests demonstrate that a one-minute residence time is preferable but if preflocculation inline is practiced by adding flocculating polymer upstream of the floc tank, the floc tank as a limitation on the capacity of the MBC system can be reduced. This preflocculation of solids before contacting the magnetite can be accomplished outside the floc tank or inside the floc tank with a series of static or hydraulic mixers. Inline preflocculation of solids before the MBC is a new and novel idea and has not been practiced or contemplated before (see FIG. 14).

Drum scrapers are usually mechanical devices that have to be adjusted for wear.

This can be done automatically by a combination of springs or as demonstrated in the patent application it can be done magnetically. A ferromagnetic stainless steel such as a 400 series stainless steel (to prevent corrosion) can be inserted as a strip in a plastic scraper material. This strip is attracted to the magnetic drum so as it wears it always stays into contact with the magnetic drum (see FIG. 17). It also makes sure that the scraper keeps in contact with the magnetic drum across its full width. This is especially important for extremely wide drums. Scraping magnetic floc off a magnetic disk can exert mechanical forces on the abrasive plastic scraper causing it to bend. Various ways can be practiced to reduce the bending of the scraper but this patent application shows how a metal rod can also be either molded into the plastic scraper or a slot can be cut into the plastic scraper to accept the metal rod that is press fitted into the slot (see FIG. 13).

The Woodard et al U.S. Pat. No. 7,695,623 describes a treatment process called Biomag (see FIG. 16a). It describes a method for adding a magnetic weighting agent, preferably magnetite, to biofloc contained in an activated sludge biological treatment system. Imbedding a weighting agent into the biofloc will increase the density of the biofloc to make it settle two to three times faster than normal and therefore is very advantageous.

To accomplish this benefit, as described in the Woodard U.S. Pat. No. 7,695,623, fine magnetite is added to the aeration basin. The reason for using a fine magnetite is; particles of different sizes do not comingle well without the use of a flocculating polymer. In fact, Cort learned from laboratory experiments that a course magnetite would not effectively imbed into a biofloc without the aid of a flocculating polymer. Also for good clarification, it is necessary to use a flocculating polymer. However when a fine magnetite was used, it imbedded into the biofloc but did not settle as quickly as when a course magnetite was used and the supernatant after settling was not clear. Therefore, course magnetite is good to use in a gravity clarifier to speed settling with the aid of a flocculating polymer but is not good for use in an aeration basin because it will not effectively imbed into the biofloc, will cause settling and cleanout problems and will increase the amount of energy needed to keep the biofloc in suspension. The Woodard U.S. Pat. No. 7,695,623 does not contemplate using flocculating polymer in the aeration basin only in the pipeline leading to the secondary gravity clarifier.

The Woodard U.S. Pat. No. 7,695,623 then shows magnetic floc, which has settled to the bottom of the secondary clarifier, is pumped either back to the aeration basin as Returned Activated Sludge (RAS) or to a magnetite cleaning and recovery system as Waste Activated Sludge (WAS). This approach has two problems. The problem of putting magnetite into the aeration basin is it increases mixing energy requirements, causes additional wear and tear on equipment due to the abrasive nature of magnetite, and can settle out in the aeration basin causing operational and clean out problems. Another problem is pumping magnetic floc out of the secondary gravity clarifier produces a dilute waste product and increases the size of the magnetite cleaning system.

This patent application describes a system where no magnetite enters the aeration basin (see FIG. 16b). This is possible because the magnetite is added to the biofloc as it is about to leave the aeration basin and before it enters the pipeline leading to the secondary clarifier. When operated like the Biomag system, biofloc that flows out of the aeration enters a MBC that combines the biofloc with magnetite and a flocculating polymer. The MBC unit performs two functions. It removes excess biofloc to be disposed of as a concentrated WAS and it forms a weighted magnetic biofloc that will settle rapidly in a secondary clarifier. The magnetic biofloc removed from the secondary clarifier is pumped back to the inlet of the MBC system located inside the aeration basin where the magnetic biofloc combines with the normal biofloc from the aeration basin. The MBC unit collects part of the magnetic floc and cleans the magnetite for reuse and biosolids from the magnetite cleaning process are either returned to the aeration basin as RAS or disposed of as WAS. The MBC can also be operated so that no biosolids enter the secondary gravity clarifier. This is an advantage when a WWTP experiences high flow rates during wet weather events. There will be no washout of biosolids during a wet weather event.

When a Biomag system is installed, it increases the footprint of the facility, increases the electrical usage, increases chemical usage, causes additional wear and tear on plant equipment, and can cause potential problems with magnetite collecting in the aeration basin. However, it is effective in increasing the clarification capacity of a plant. Then the bottleneck in the plant can revert to the biological treatment system.

When a MBC is installed, it does not increase the electrical usage to any significant amount and will not cause problems with magnetite in the aeration basin. The inline MBC can be placed inside the aeration tank and therefore does not increases the footprint of the plant.

This patent application proposes using a courser magnetite (greater than 40 micron) to enhance settling in the gravity clarifier and because this magnetite does not enter the aeration basin it does not cause problems with increased mixing energy to keep it in suspension, will not deposit in the aeration basis, and will not have problems imbedding into a biofloc since flocculation is aided by a flocculating polymer.

There is little value in adding magnetite to an aeration basin, and in fact, this practice results in higher costs to add more magnetite to fully treat the whole aeration basin. A better solution is to add magnetite to the biofloc after it exist the aeration basin and before it enters the MBC system that is mounted inside the aeration basin.

In summary, when you add magnetite after biological treatment to form a magnetic floc inline, you can use a courser magnetite, which is cheaper and more readily available in the marketplace. You do not have to worry about magnetite settling out in the aeration basin or how well the magnetite imbeds into a biofloc without the aid of a flocculating polymer or using extra energy to keep magnetic biofloc in suspension in the aeration basin. Using a courser magnetite will greatly increase the settleability of the weighted biofloc in the secondary clarifier and therefore increase its capacity.

One way to increase the biological treatment capacity of the plant is to add biocarriers to increase the amount of biofilm in the aeration basin. This patent application describes the combination of magnetic clarification technology either Biomag or MBC with the conversion of the activated sludge system to a MBBR, which contains biocarriers. This is by far the best combination of biological treatment technology and magnetic clarification technology because the MBBR produces a lesser amount of biosolids, improves water quality, reduces sludge generation, and is tolerant of toxic shock. In an activated sludge system the Mixed Liquor Suspended Solids (MLSS) ranges from 2000 to 5000 mg/I. In a MBBR, the MLSS ranges from 300-800 mg/I. This lower level of suspended solids reduces the load on the MBC or Biomag magnetite cleaning systems.

Gravity clarification and DAF are operated under atmospheric pressure conditions and in most applications this is advantageous because water can flow by gravity through these systems, however there are some applications where operating a clarification technology under pressure is advantageous. For example, if a clarifier is followed by final filtration, the final filter may be a pressure filter to save space or if the effluent has to be raised for final discharge, operating the MBC under pressure will eliminate a final transfer pump. This patent application describes a novel way to operate a MBC under pressure (see FIGS. 18, 19a, 19b, 20a, and 20b).

A technology that is used to treat large flow rates of storm water is the vortex separator. It uses centrifugal forces to cause suspended solids in storm water to separate from the storm water and settle to the bottom of the vortex separator to be discharged as waste. Its main advantages are it is a passive system that can startup up quickly and can treat large amounts of storm water in a small amount of space. It can effectively remove large solids called grit that settles rapidly and it can effectively remove floatables. However, it cannot effectively remove fine suspended solids that do not settle well. Therefore the water looks a lot better because floatables have been removed and build up of settleable solids is reduced downstream, however the vortex separator does not remove a majority of the pollutants such as oil and grease, heavy metals, and nutrients are not removed by a vortex separator. This is because the majority of pollutants are associated with the fine solids because of their large surface area and since vortex separators do not remove fine suspended solids well, a high percentage of pollutants remain in from the water and the water usually does not look any clearer. Therefore, there is a significant need to improve the operation of vortex separators to treat storm water and this patent application shows how MBC can be integrated with a vortex separator to remove those fine suspended solids than cannot be removed by a vortex separator by itself (see FIG. 21).

This patent application describes the placement of a floating suction in a pond or lagoon to withdraw water at a constant rate. The water flowing out of a pipeline connected to the pond or lagoon is preferably a floating pipeline made of lightweight plastic. As the water flows through the pipeline, magnetite and flocculating polymer is added to cause the magnetite to floc together with the fine suspended solids in the wastewater. This magnetic floc then flows to a magnetic collector that is designed to remove the magnetic floc from the water so a magnetite cleaning system can break the floc separating the magnetite from the suspended solids. The suspended solids are then disposed and the magnetite reused in the treatment process. FIG. 22 shows this novel layout of equipment and is the only time that inline flocculation has been performed with magnetite to treat wastewater coming from a pond or lagoon. It is also the first time a vertically mounted completely submerged magnetic collector composed of magnetic disks has been used to extract the magnetic floc from a flowing stream of water. The treatment process shown in FIG. 22 will function in a simpler fashion when the flow of water from the pond or lagoon is constant. This allows for a constant dose rate of flocculating polymer assuming that the level of solids in the water remains relatively constant. A floating suction is the easiest way to assure a constant flow of water out of a pond or lagoon.

Storm events produce large quantities of polluted water that damage the environment. A common strategy to reduce this impact on the environment is the use of impoundment structures to allow suspended solids that contain much of the pollution to settle out by gravity. However, these suspended solids are often very small in size and do not settle well and in some cases not at all. Therefore, to treat these large flows of storm water that can in some cases also contain sanitary wastes, it is necessary to increase the settling clarification capability of these impoundment structures that can be manmade concrete basins, lagoons, or ponds.

The preferred approach to increasing the clarification capacity of impoundment structures it to use magnetite and flocculating polymers to form a magnetic floc that captures the suspended solids contained in the storm water. The suspended solids can be organic or inorganic in nature. When there are dissolved pollutants contained in the storm water, it is often necessary to add precipitating agents. In the case of heavy metals this can be the addition of sulfides to precipitate the heavy metals to form suspended solids. In the case of phosphorous, this can be the addition of metal salts such as iron or aluminum to precipitate phosphorus as either iron phosphate or aluminum phosphate.

Storm water flows through a conveyance system such as a culvert, pipeline, or open channel into an impoundment structure. It is in this conveyance system that magnetite, flocculating polymer, and possibly a precipitating agent is added to form a magnetic floc that can be easily removed by a magnetic device or will rapidly settle by gravity in the impoundment structure. Due to the high flow rates while it is possible to remove the magnetic floc from the flowing stream of water, it is preferable to allow the magnetic floc to settle by gravity in the impoundment structure and then at a later date remove the magnetic floc to remover the magnetite and to disposes of the suspended solids attached to the magnetite.

Flow of the storm water containing the magnetic floc into the impoundment structure can be directed in a way that enhances settling and the recovery of the settled magnetic floc. For example, flow can be directed to the perimeter of the impoundment structure so that magnetic floc will settle into areas that facilitate the removal and treatment of the magnetic floc. Also, the flow can be directed in a circular path that lengthens the pathway of the water flow through the impoundment structure to prevent short-circuiting. This will lengthen the time allowed for settling.

Magnetic floc that has settled in the impoundment structure can be removed either magnetically by a magnetic device that raises the magnetic floc from the bottom of the impoundment structure to the water's surface where the magnetic floc can be treated to recover the magnetite or a the magnetic floc can be pumped off the bottom of the impoundment structure with a dredging device.

In summary, this invention converts an impoundment structure into a clarifier that functions much like a vortex separator (see FIG. 23). However, the flow of water through the impoundment structure does not have to be circular but can be directed in any way that facilities the settling of magnetic floc and the removal of magnetic floc. Flow diverting curtains can be used in the impoundment structure to direct the flow of water in any direction.

### BRIEF DESCRIPTION OF THE DRAWINGS

Other objects, features and advantages will occur to those skilled in the art from the following description of a preferred embodiment and the accompanying drawings, in which:

FIG. 1 shows the top view of a MBC system with the newly designed magnetic collector.

FIG. 2 shows the side view of a MBC system with the newly designed magnetic collector.

FIG. 3 shows the details of the MBC components and the physical relationship between the final magnetic collector (5), the shear device (6), and the magnetic drum (7).

FIG. 4 shows the side view of a horizontal magnetic disk collector with a center cutout that allows water to flow perpendicular to the magnetic disks.

FIG. 5 shows the details in a top and side view of a magnetic disk that contains rare earth magnets and an opening in the center of the magnetic disk to allow the flow of water from the MBC.

FIG. 6 shows the same magnetic disk in FIG. 5 but with a stiffener device molded or placed inside the magnetic disk.

FIG. 7 shows the side view of the horizontal magnetic disks that function as a magnetite filter.

FIG. 8 shows the details of a magnetic disk that functions as a magnetite filter and contains ferrite magnets and an opening in the center of the magnetic disk to allow the flow of water out of the MBC.

FIG. 9 shows the details of a magnetic drum with an outer metal sheet to hold magnets in place while an adhesive that holds them in place is setting up.

FIG. 10 shows the optimum layout of permanent magnets inside a hollow PVC drum.

FIG. 11 shows a top and side view of a typical shear blade with cutouts to increase shear performance.

FIG. 12 shows the end view of a shear tube with included shear blade. It also shows the relative positioning of the inlet and outlet slots.

FIG. 13 shows a typical shear blade used between magnetic disks. Also shown is the use of a stiffing rod to prevent flexing of the shear blade during operation.

FIG. 14 shows the details of an in-line MBC system with a mechanical magnetite cleaning system.

FIG. 15 shows the details of an in-line MBC system with a water jet magnetite cleaning system.

FIG. 16a shows the details of a Biomag system for comparison purposes with MBC.

FIG. 16b shows the details of an inline MBC integrated with a biological treatment system for comparison purposes with Biomag.

FIG. 17 shows two scraper details. The top detail shows a magnetic drum scraper with a ferromagnetic strip to maintain that the scraper is affixed to the magnetic drum. The bottom detail shows a disk scraper that is formed into a shape that wraps around and is suspended from a rotating shaft.

FIG. 18 shows the details of a pressurized MBC with the magnetic collector in a horizontal position.

FIG. 19a shows the side view of a pressurized MBC with the magnetic collector in a vertical position

FIG. 19b shows the top view of a pressurized MBC with the magnetic collector in a vertical position.

FIG. 20a shows a complete MBC system with the side view of a magnetic collector that is completely submerged in a flowing stream of water.

FIG. 20b also shows a complete MBC system but with a top view of the same magnetic collector that is completely submerged in a flowing stream of water.

FIG. 21 shows how a MBC unit can be integrated with a vortex separator to remove fine suspended solids from storm water.

FIG. 22 shows the use of MBC to treat wastewater discharging from a pond or lagoon.

FIG. 23 shows the application of MBC to storm water treatment in impoundment structures.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

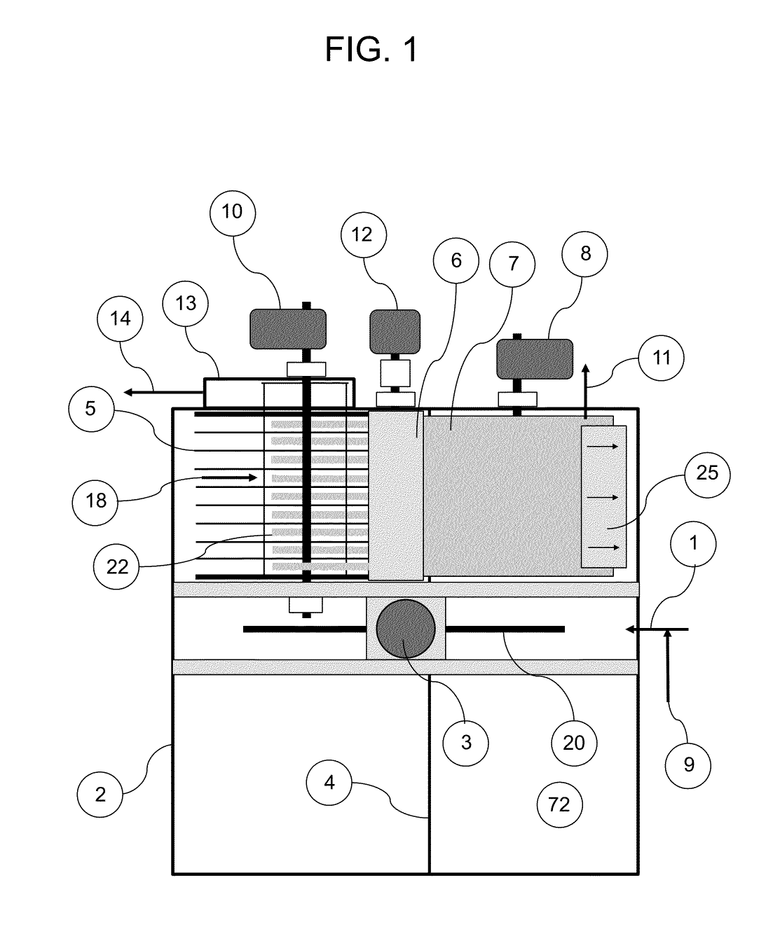

FIG. 1 shows the top view of the MBC (2) with water (1) flowing into a flocculating section (72) of the MBC (2) separated by a baffle (4) to prevent short-circuiting of flow in the MBC (2) where flocculating polymer (9) is added to cause the suspended solids in the water to attach to magnetite already present in the MBC (2) to form a magnetic floc with the aid of a mixer gear motor (3) that drives a mixer blade (20). Water that contains this magnetic floc flows under a baffle (4) and into a zone where contained is a plurality of magnetic disks (5) driven by a gearmotor (10). The water and magnetic floc then flows (18) radially from the perimeter of the magnetic disks (5) to the center of the magnetic disks (5) and into a discharge trough (13) and out of the MBC (2) through a pipeline (14). The magnetic floc that attaches to the magnetic disks (5) is scraped off with mechanical scrapers (22) located between the magnetic disks (5) and rises out of the water and into a shear device (6) driven by a motor (12). In the shear device (6), magnetite is separated from the suspended solids and the sheared liquid flows onto a magnetic drum or plurality of magnetic disks (7) driven by a gearmotor (8). The magnetic drum or plurality of magnetic disks (7) that contains rare earth magnets collects the magnetite, which is then scraped off with a mechanical scraper (25) back into the floc section of the MBC (2). The non-magnetic waste that does not adhere to the magnetic drum or plurality of magnetic disks (7) is collected in a trough (26) and disposed through a pipeline (11).

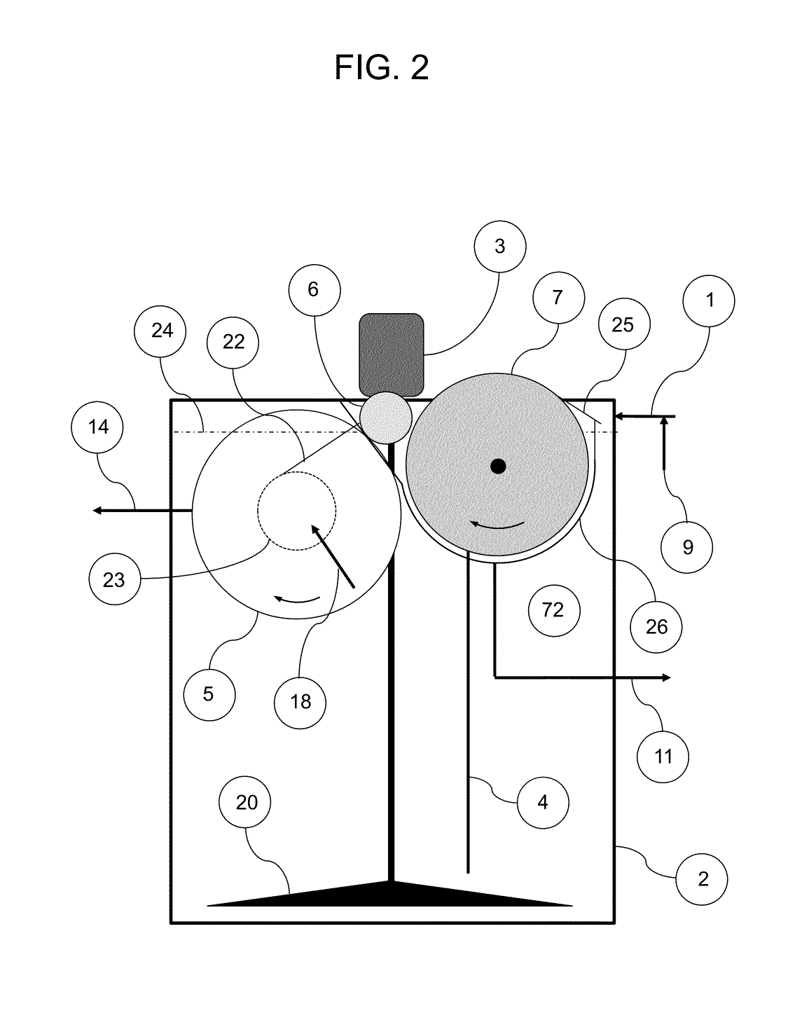

FIG. 2 shows the side view of the MBC (2) with water (1) flowing into a flocculation section (72) of the MBC (2) separated by a baffle (4) to prevent short-circuiting of flow in the MBC (2) where flocculating polymer (9) is added to cause the suspended solids in the water to attach to magnetite already present in the MBC (2) to form a magnetic floc with the aid of a mixer gear motor (3) that drives a mixer blade (20). Water that contains this magnetic floc flows under a baffle (4) and into a zone where contained is a plurality of magnetic disks (5) driven by a gearmotor (10). The water and magnetic floc then flows (18) radially from the perimeter of the magnetic disks (5) to the center of the magnetic disks (5) and into a discharge trough (13) and out of the MBC (2) through a pipeline (14). The magnetic floc that attaches to the magnetic disks (5) is scraped off with mechanical scrapers (22) located between the magnetic disks (5) as the plurality of magnetic disks (5) rotate in a clockwise direction the magnetic floc rises out of the water and flows into a shear device (6) driven by a motor (12). In the shear device (6), magnetite is separated from the suspended solids and the sheared liquid flows onto a magnetic drum or plurality of magnetic disks (7) driven by a gear motor (8). The magnetic drum or plurality of magnetic disks (7) that contains rare earth magnets collects the magnetite, which is then scraped off with a mechanical scraper (25) back into the MBC (2). The non-magnetic waste that does not adhere to the magnetic drum or plurality of magnetic disks (7) is collected in a trough (26) and disposed through a pipeline (11).

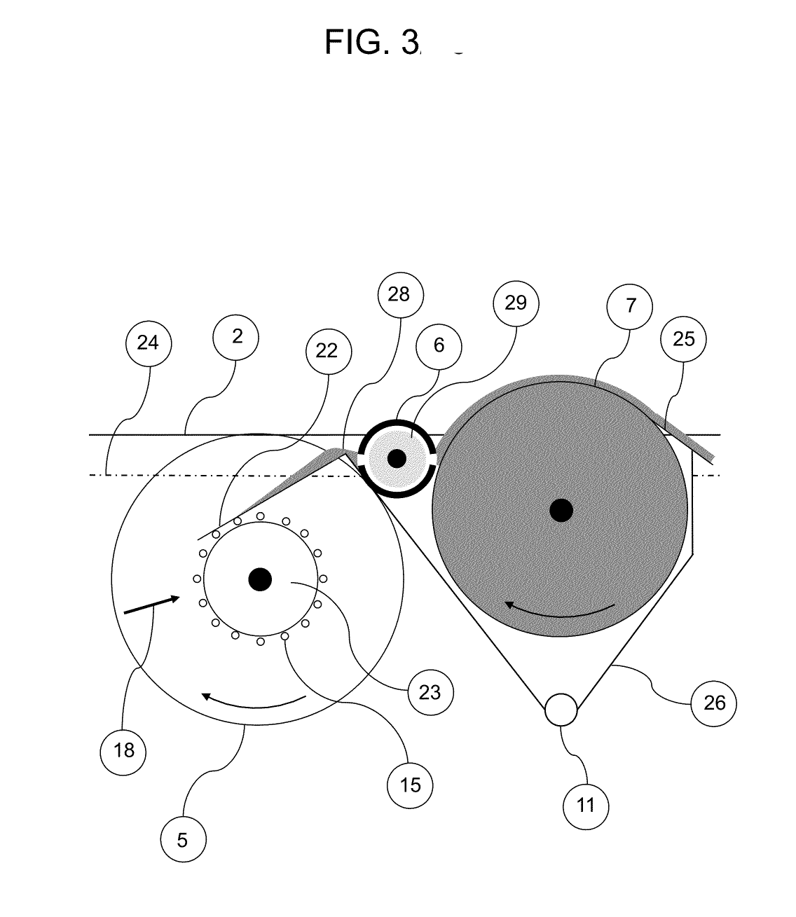

FIG. 3 shows the positioning of the magnetic disks (5), the shear device (6) that contains shear blades (29), and the magnetic drum (7) contained in the MBC (2). As water flows (18) from the perimeter of the magnetic disks (5) to their center (23), magnetic floc (28) adheres to the rotating magnetic disks (5) and rises out of the water and above the water line (24) caused by the scrapers (22) located between the magnetic disks (5). The magnetic disks (5) as they rotate in a clockwise direction create forces that move the magnetic floc (28) out of the water to form a mound that as it increases in size overflows into the shear device (6). This mound of magnetic floc (28) creates a barrier that prevents excess water from the rotating magnetic disks (5) to flow into the shear device (6), thus reducing the amount of waste generated. Located in the magnetic disk (5) are holes (15) that contain rods that connect the magnetic disks (5) together. The magnetic floc (28) that flows into the shear device (6) is subjected to mechanical forces that separate the magnetite from the suspended solids. The sheared magnetic floc then flows onto a magnetic drum (7) or magnetic disks where the attached magnetite is scraped off with a scraper (25) and flows back into the MBC (2). Non-magnetic material that does not attach to the magnetic drum (7) flows to the bottom of the trough (26) and is disposed through a pipeline (11). The top of the trough (26) is above the water line (24) to prevent water overflowing from the MBC (2) into the waste pipeline (11).

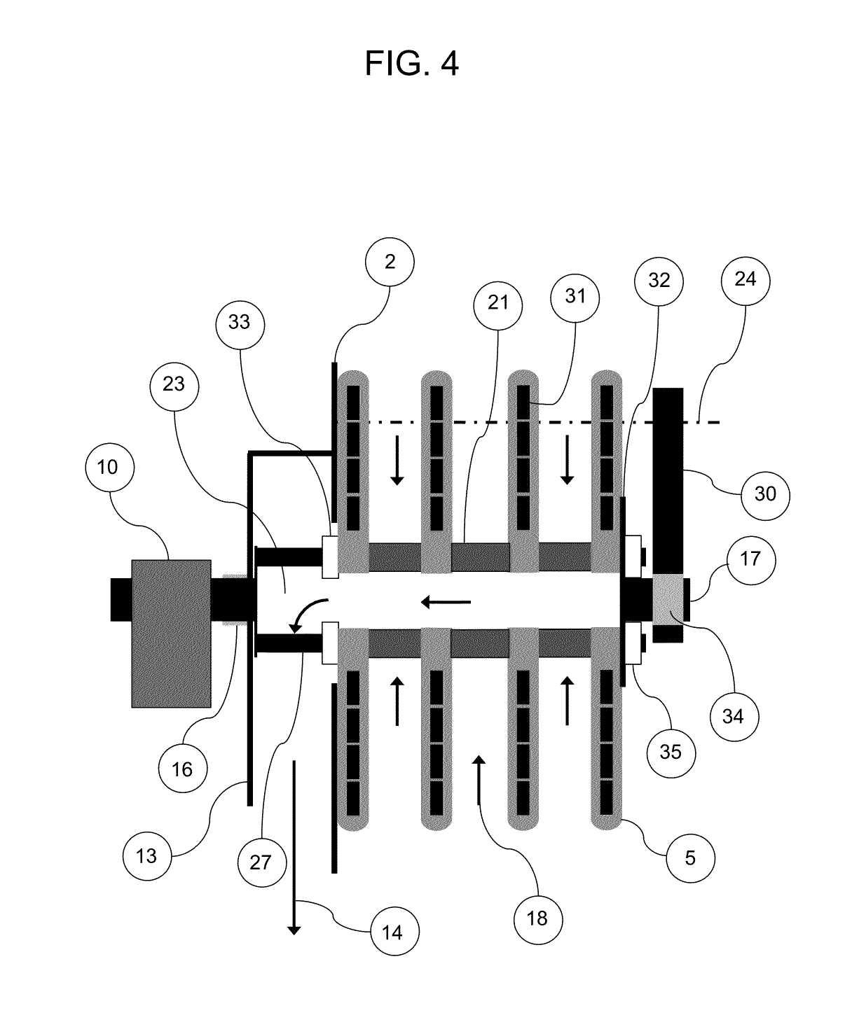

FIG. 4 shows the side view of the final magnetic collector contained in the MBC (2). Water (18) that contains magnetic floc flows between parallel magnetic disks (5) and into a center cutout (23) in the magnetic disks (5) and out of the MBC (2) through a discharge trough (13) and into a pipeline (14). The magnetic collector of the MBC (2) system consists of a plurality of magnetic disks (5) that contain permanent magnets (31) and are connected together with rods (27) each equipped with a retaining ring (33) and a tightening nut (35). At the end of this plurality of magnetic disks (5) is an end plate (32) that prevents water (18) from flowing through the end magnetic disk (5). A gear motor (10) drives the plurality of magnetic disks (5) and spacers (21) separate the magnetic disks (5). The plurality of magnetic disks (5), supported by an end bracket (30), rotates through two bushing or bearings (16 and 34) that supports the shaft (17) and gear motor (10).

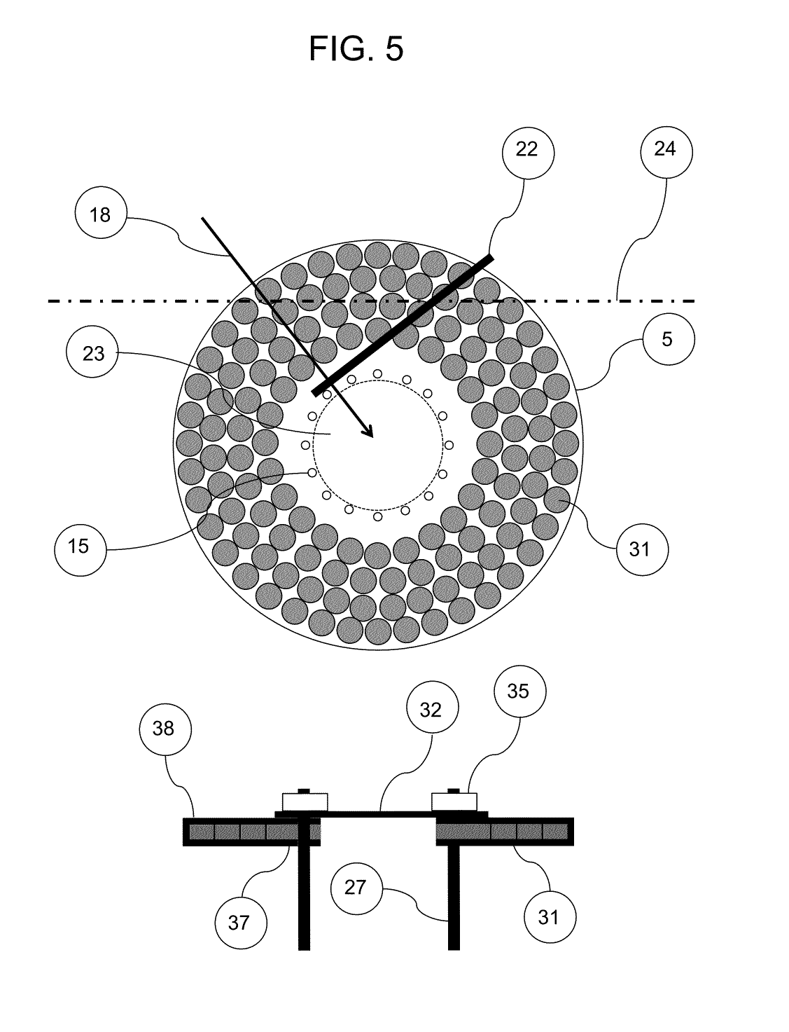

FIG. 5 shows the details of a magnetic disk (5). The magnetic disk (5) is composed of plastic material imbedded with rare earth permanent magnets (31). When water (18) containing magnetic floc flows across the magnetic disks (5) radially, the clarified water that now contains no magnetic floc exits through a center cutout (23) in the magnetic disks (5). The magnetic disks (5) contain holes (15) for support rods (27) that connect the magnetic disks (5) together. These rods (27) also provide support for scrapers (22) positioned between the magnetic disks (5). The magnetic disks (5) are positioned with a portion extending above the water line (24) so that as the magnetic disks (5) rotate in the clockwise direction, magnetic floc contacts the scrapers (22) causing the magnetic floc to rise above the water line (24). The magnetic disk is composed of rare earth magnets (31) sandwiched between two plastic sheets (37 and 38) or imbedded in a poured thermosetting plastic material. Connecting the magnetic disks (5) together are rods (27) and a tightening nut (35). Also an end plate (32) prevents water from passing through the end magnetic disk (5).

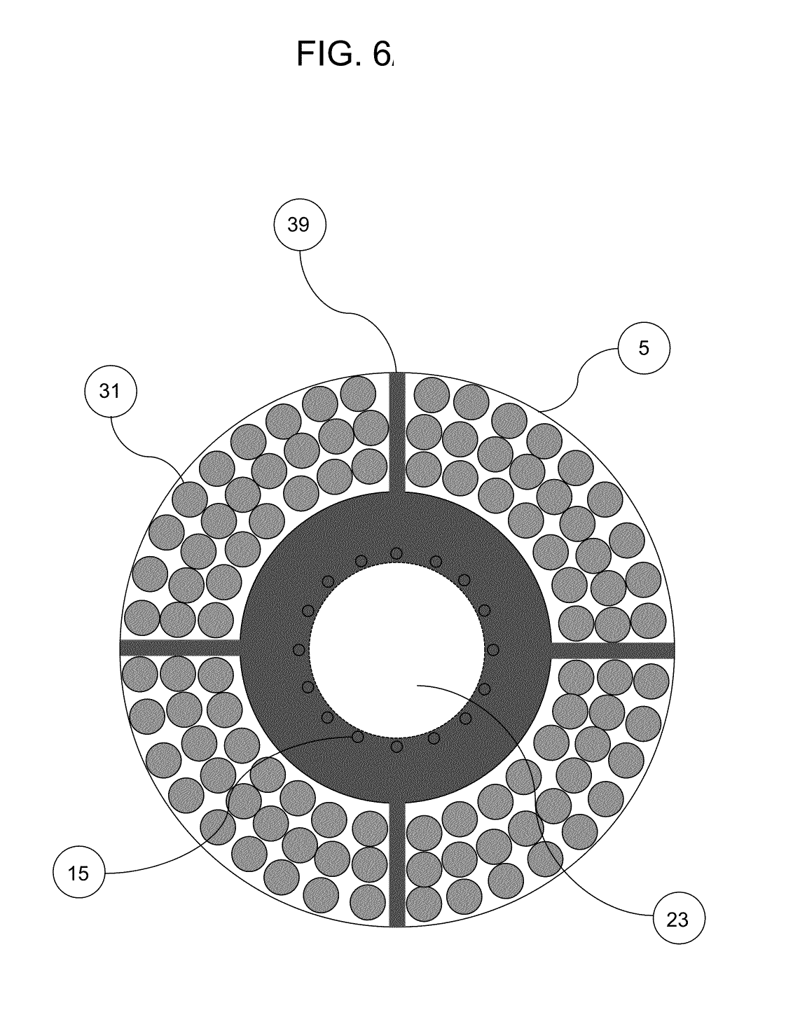

FIG. 6 shows the same magnetic disk depicted in FIG. 5 with the exception that a stiffing insert (39) is molded into the magnetic disk (5) to provide dimensional stability needed for large magnetic disks (5).

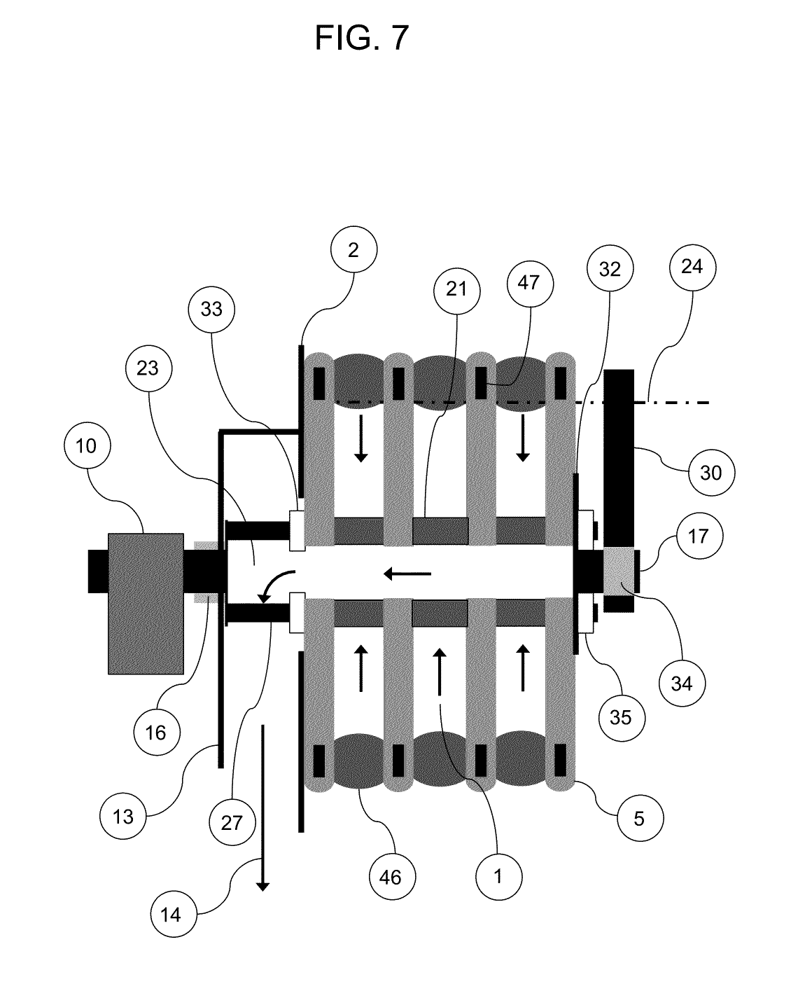

FIG. 7 shows the same details to a MBC (2) magnetic collector as shown in FIG. 4 with the exception that only ferrite magnets (47) are imbedded along the perimeter of the magnetic disk (5) and between these magnets (47), magnetite (46) is allowed to bridge to form a filter barrier. The magnets (47) used in this application have less magnetic force to hold magnetite (46) and can be constructed out of lesser ferrite or similar magnetic material. This allows stronger magnets such as rare earth neodymium iron boron magnets to remove the magnetite bridging between the magnetic disks (5) being held by weaker ferrite or similar magnets. This arrangement forms a magnetic filter device.

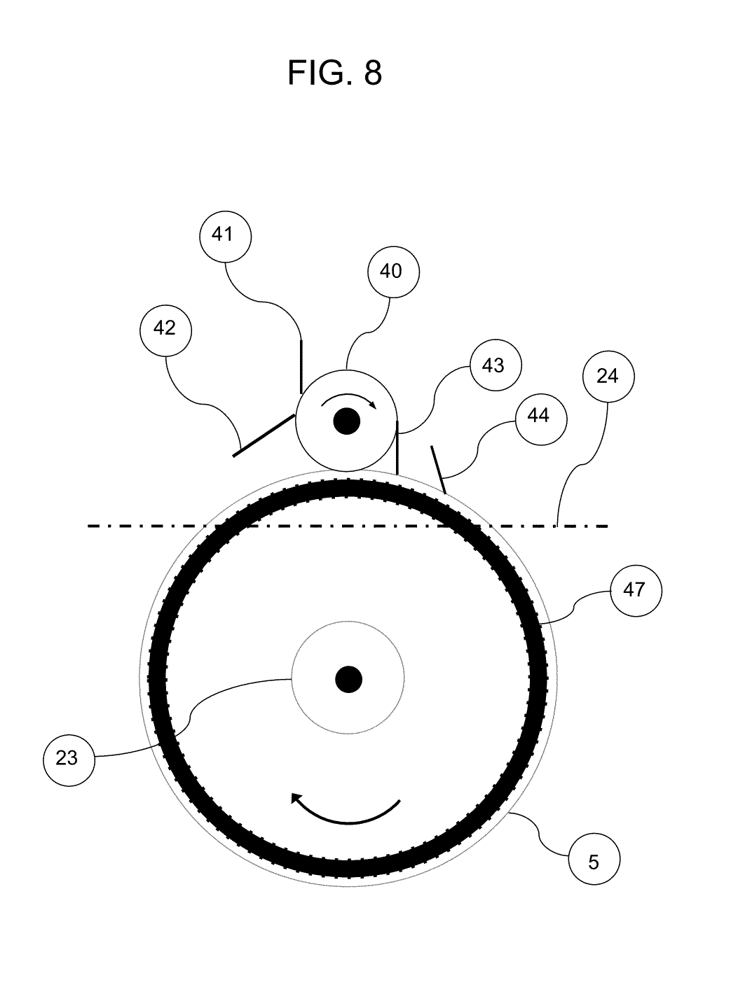

FIG. 8 shows an end view of the magnetic filter shown in FIG. 7 with the added details of a magnetic drum (40) that as it rotates it removes the magnetite collected between the magnetic disks for cleaning purposes. As the magnetic drum (40) rotates in a clockwise direction, a spray device (41) dislodges solids from the magnetite and this waste exists the system at (42). A scraper (43) cleans the magnetic drum (40) and the cleaned magnetite is redeposited onto the magnetic filter (5). A leveling device (44) assures that the magnetite is evenly deposited on the magnetic filter (5).

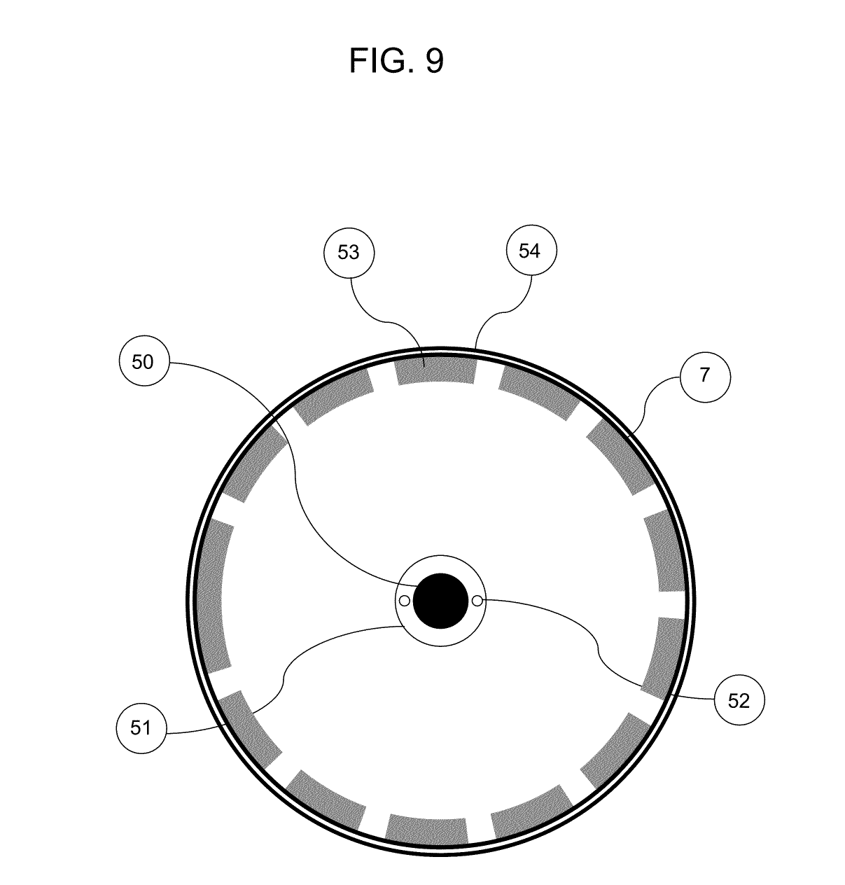

FIG. 9 shows an iron metal sheet (54) placed around a PVC hollow duct (7) that will contain permanent magnets (53). A horizontal shaft (50) runs through the PVC duct (7) and is attached to the end plate of the duct with a shaft collar (51) with holes (52) for attachment screws. The purpose of the iron metal sheet (54) is to hold the permanent magnets (53) in place until they can be permanently secured with adhesive and protective coating to prevent corrosion. Otherwise the permanent magnets (53) would attract to each other and clump together.

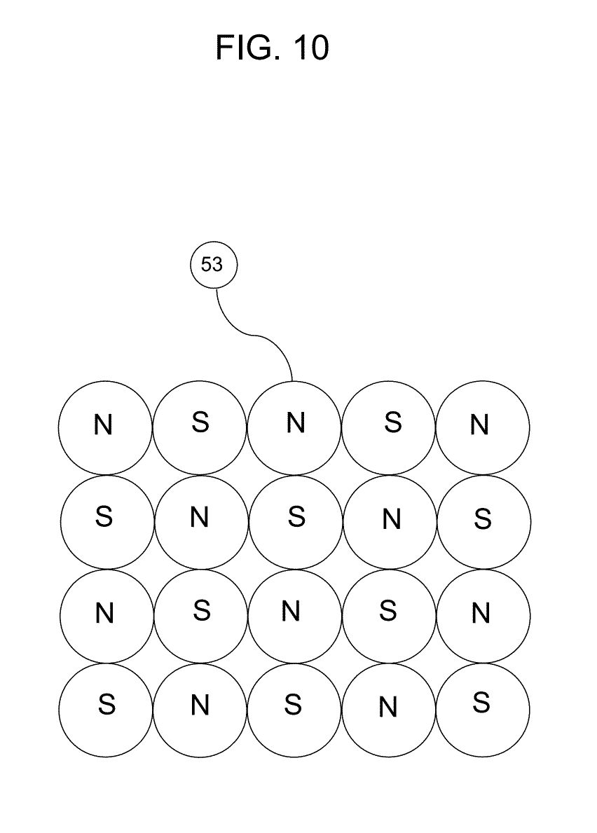

FIG. 10 shows the polarity arrangement of the permanent magnets (53) inside the magnetic drum. This arrangement affords the greatest concentration of permanent magnets (53) inside the PVC duct.

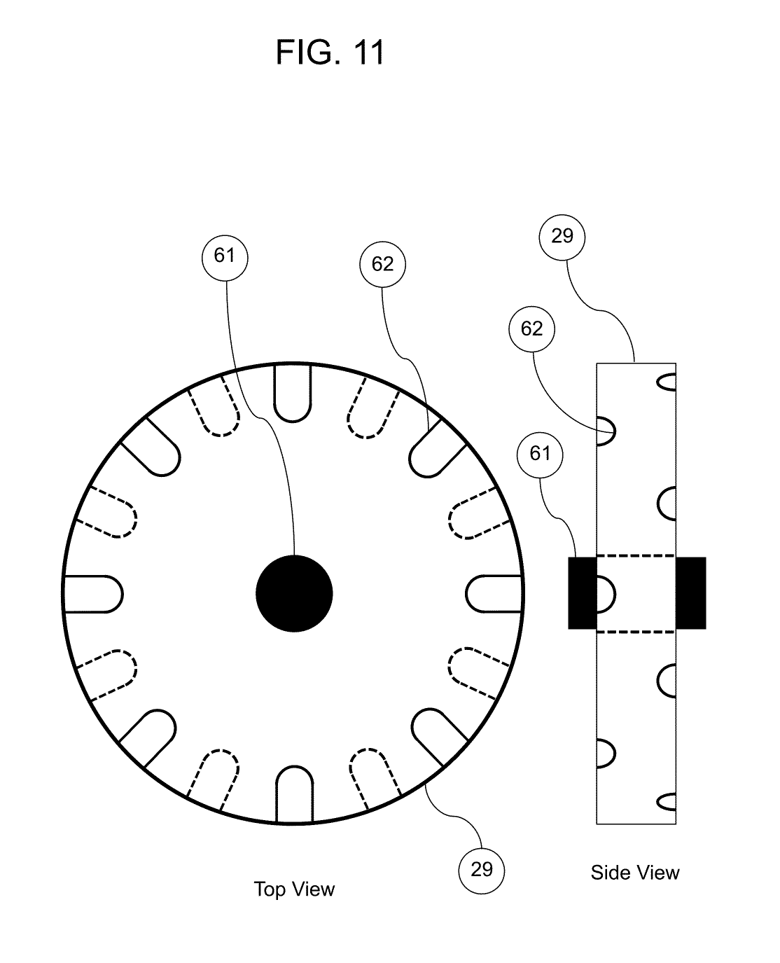

FIG. 11 shows two views of the depressions (62) formed on the surface of a shear disk (60). A plurality of shear disks (60) is press fitted together onto a connecting shaft (61) that rotates the shear disks. The purpose of these depressions (62) is to cause added shear turbulence as the shear disks (60) rotate at a speed of 1750 rpm. Another purpose of the depressions (62) is they cause a pumping action that forces the sheared magnetic floc to exist the shear tube.

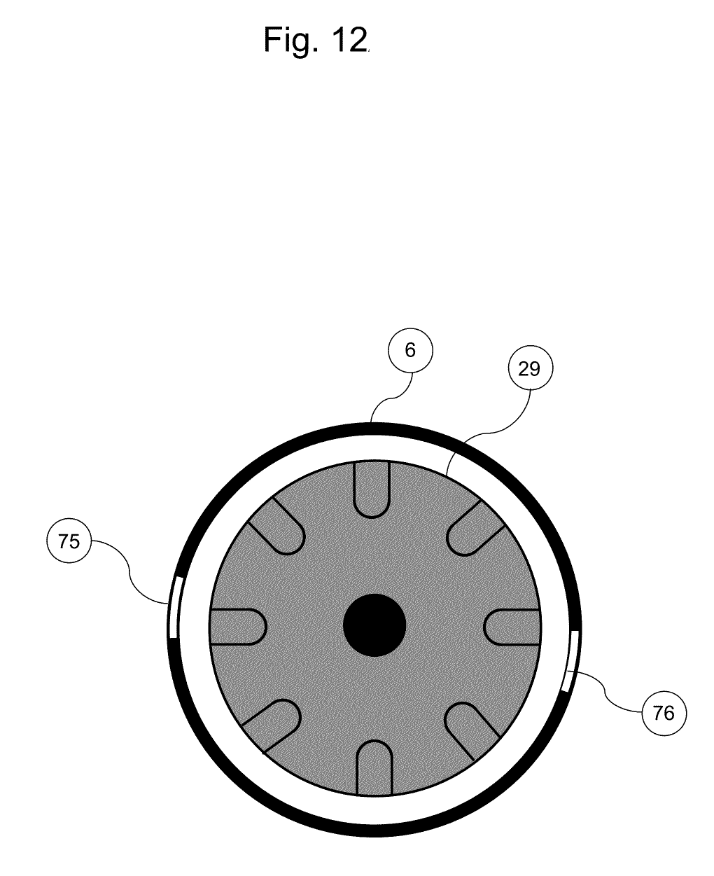

FIG. 12 shows a shear tube (6) with a shear disk (29) contained therein. Also shown are an inlet slot (75) that allows sheared magnetic floc to enter the shear tube (6) by gravity and an outlet slot (76) positioned below the inlet slot (75) to allow the sheared magnetic floc to exit the shear tube (6) also by gravity.

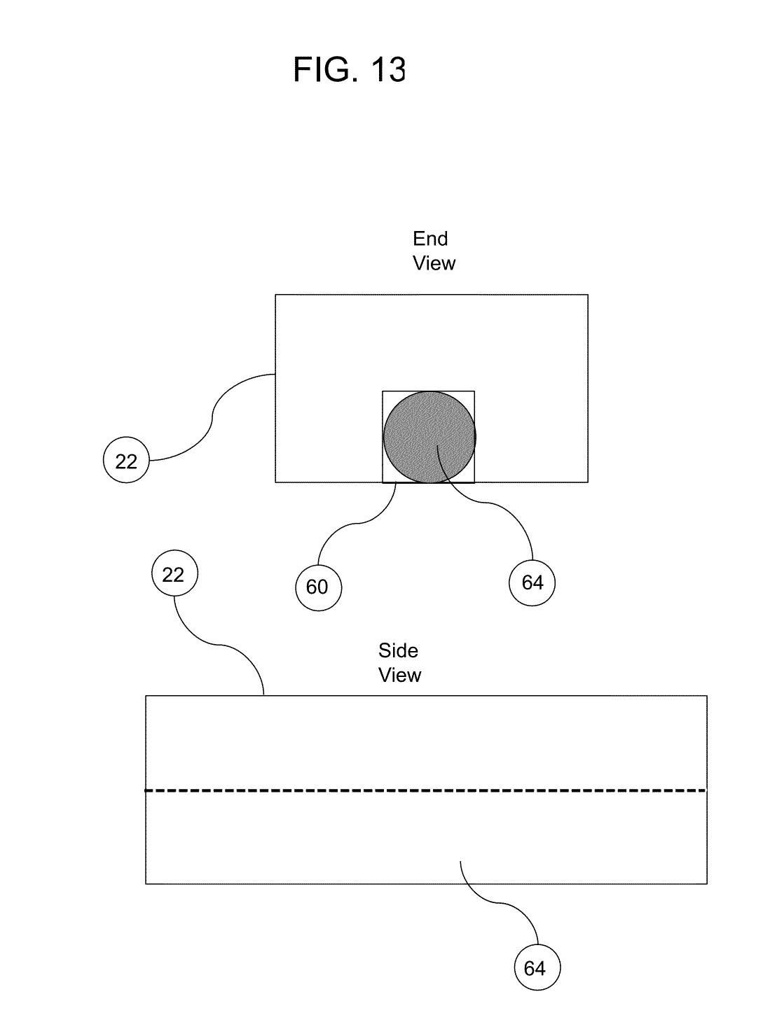

FIG. 13 shows a magnetic disk scraper (22) constructed with a non-magnetic abrasion resistant plastic. Since the scraping forces on the disk scraper are significant, a reinforcing corrosion resistant stainless steel rod (64) is press fitted into a slot (60) cut into the magnetic disk scraper (22).

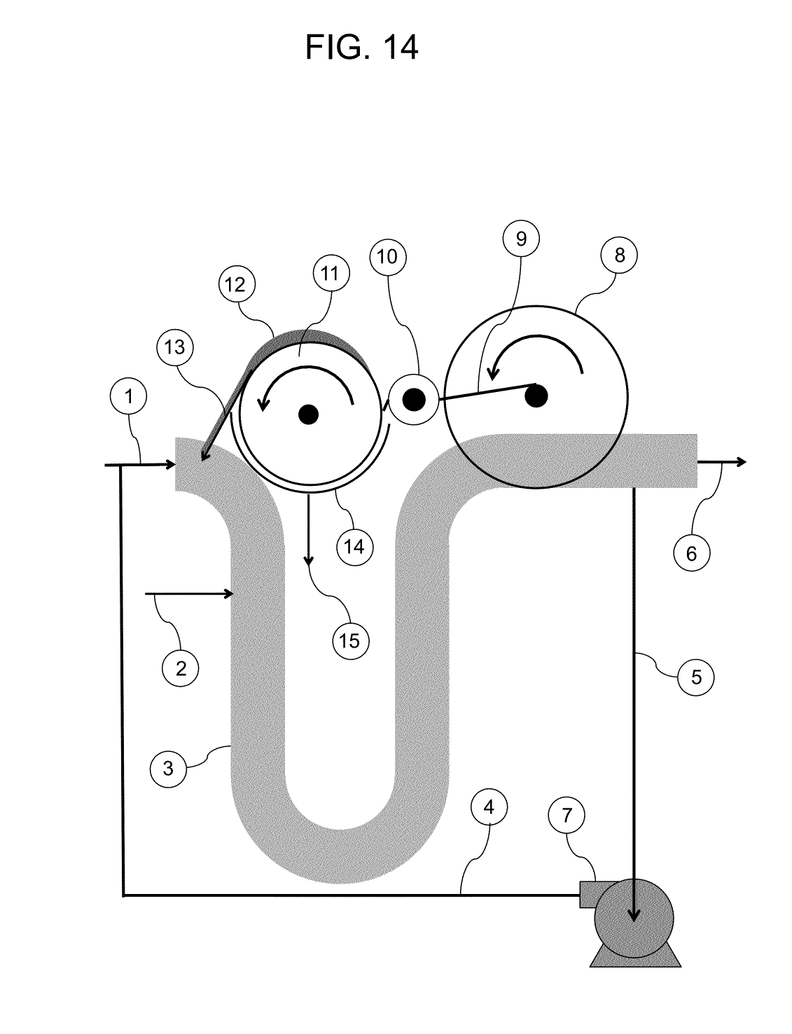

FIG. 14 shows the details of an in-line MBC where unclarified water (1) containing suspended solids flows into a flocculation pipeline (3) and combines with clean magnetite (12) and with a flocculating polymer (9). This combination of suspended solids in the unclarified water, magnetite, and flocculating polymer comes together to form a floc in the pipeline (3). The velocity of water in the pipeline (3) is sufficient to cause a flocculation that is now magnetic in nature because of the magnetite. This magnetic floc then flows through a plurality of disks (8) attached to a horizontal rotating shaft. Imbedded in the disks (8) are permanent rare earth magnets that collect the magnetic floc. As the disks (8) rotate, they raise the affixed magnetic floc out of the water until the magnetic floc comes into contact with a scraper (9) that forces the magnetic floc to the perimeter of the disks (8) where it then flows into a mechanical shear device (10). The mechanical shear device (10) is composed of a tube containing a rotating shaft, which has attached a plurality of shear disks. These rotating disks cause the magnetite to separate from the suspended solids and this sheared mixture exits the shear tube and onto a magnetic device that is preferably a rotating drum (11) containing permanent magnets. The magnetite (12) is held onto the magnetic drum by permanent magnets contained therein. As the magnetic drum (11) rotates, a scraper (13) removes the cleaned magnetite (12) from the magnetic drum (11) and the scraped magnetite then flows back by gravity into the flocculation pipeline (3) to be reused. Non-magnetic suspended solids that do not adhere to the magnetic drum (11) flow by gravity into a trough (14) and are discharged as waste through a pipeline (15). Clarified water exits the MBC system through a pipeline (6). In applications where the flow (1) is variable and drops below the point where in-line flocculation is no longer effective, an optional recirculation pump (7) is provided to increase the volume of water flowing through the MBC system. Recirculated clarified water flows through a pipeline (5) to a recirculation pump (7). Discharge from the recirculation pump (7) flows through a pipeline (4) and back into the inlet flow of unclarified water (1).

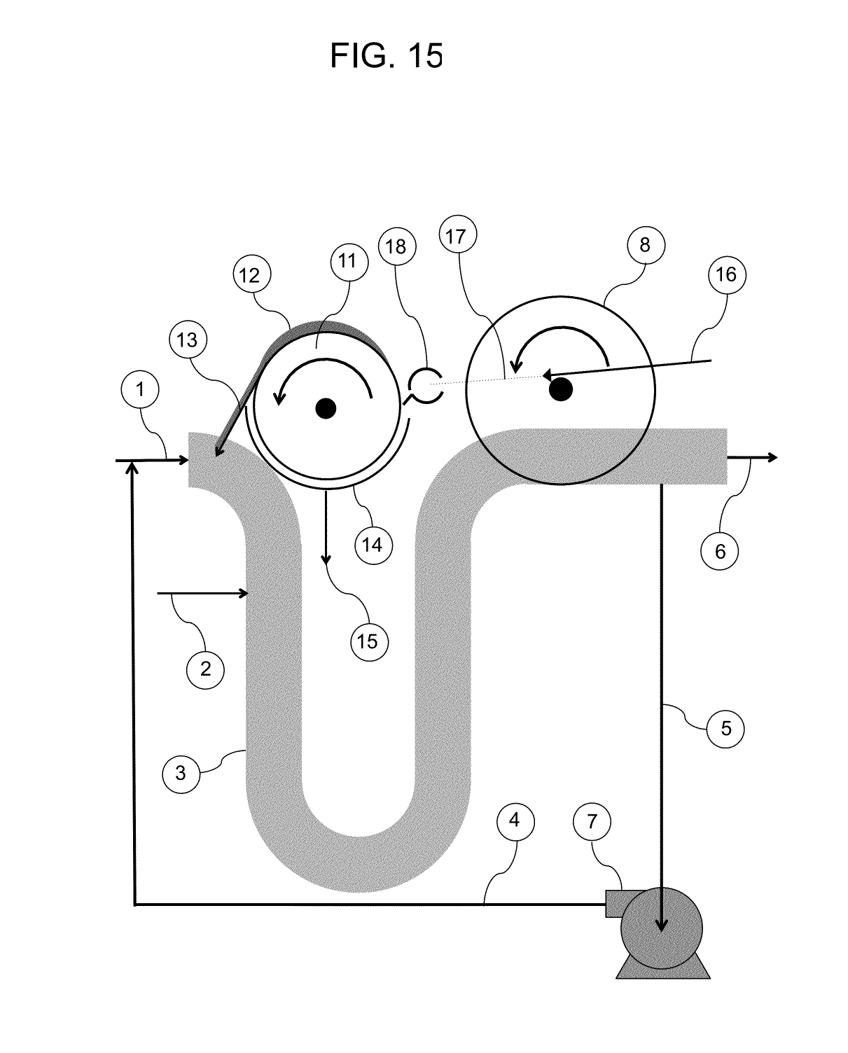

FIG. 15 shows the details on another embodiment of FIG. 1 with the exception that the magnetic floc is now sheared with a high-pressure water stream (17). The high-pressure water stream (17) flowing out of a pipe (16) not only dislodges the magnetic floc from the magnetic disks (8) but also shears the floc to separate the magnetite from the suspended solids. The sheared sludge then impacts against a stationary device (18) and flows to a magnetic drum (11) to separate the magnetite from non-magnetic solids.

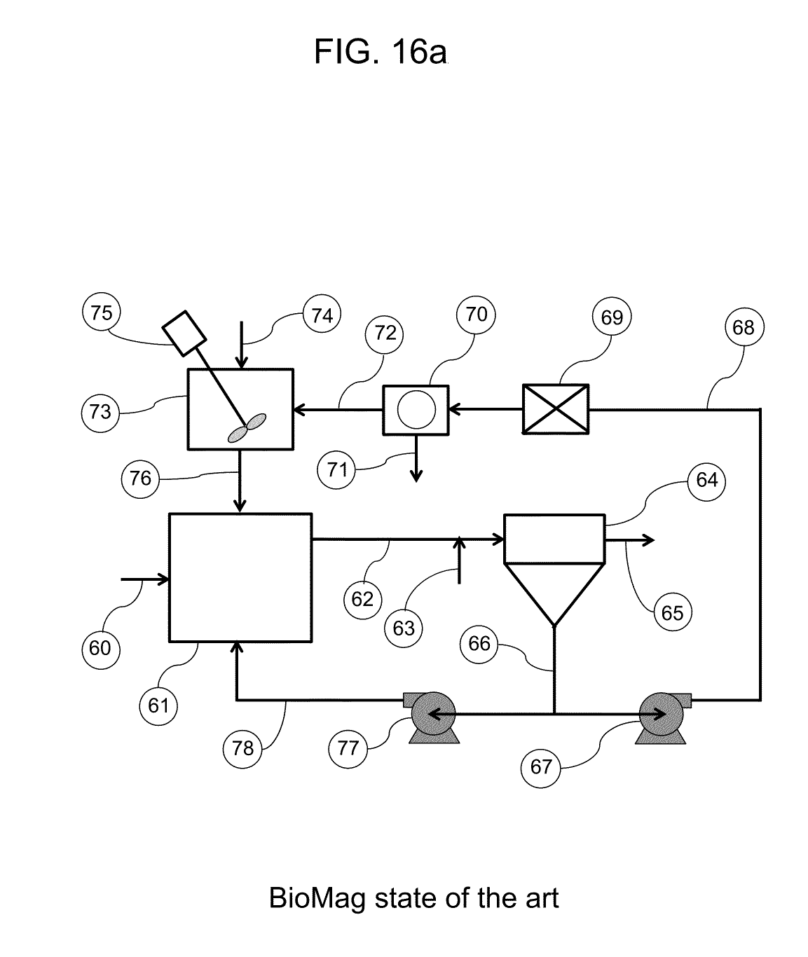

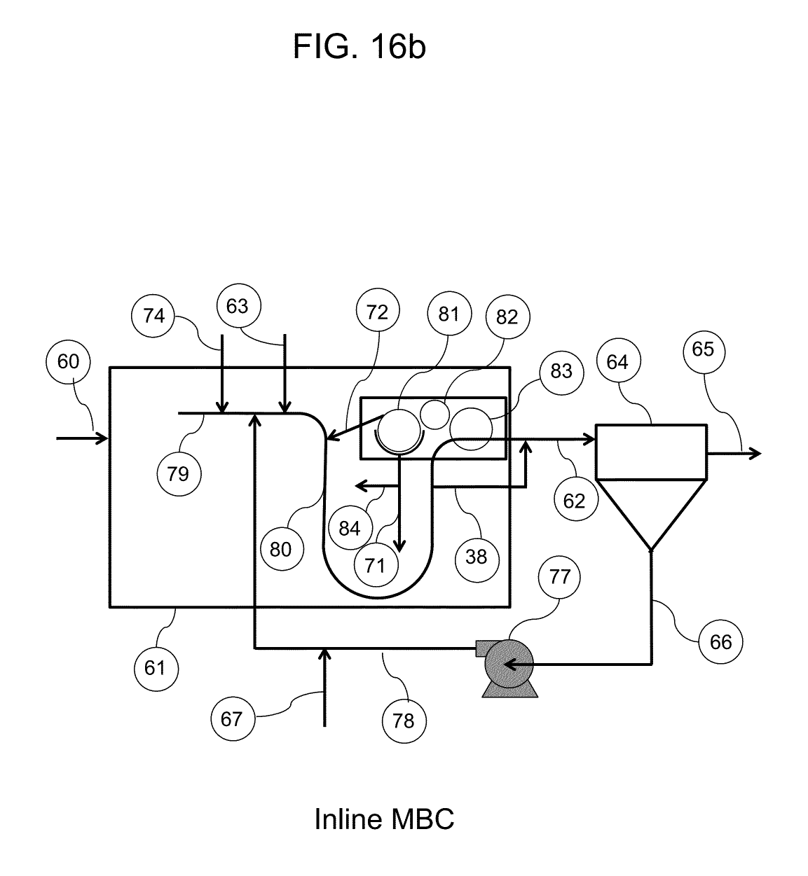

FIG. 16a shows a Biomag system for comparison to a MBC biological treatment system shown in FIG. 5b. In the Biomag system shown in FIG. 5a, wastewater (60) flows into an activated sludge basin (61) where biofloc is formed. Fresh magnetite (74) and cleaned magnetite (72) are combined in a mix tank (73) equipped with a mixer (75) and this combined magnetite mixture then flows through a pipeline (76) and into the activated sludge basin (61) where it imbeds into the biofloc thus making the biofloc magnetic. The magnetic biofloc then exists the activated sludge basin (61) through a pipeline (62) where they may combine with a flocculating polymer (63) to cause any small bioflocs that may not be heavy enough for good settling in the gravity clarifier (64) to attach to larger bioflocs that contain enough magnetite to make the biofloc heavy enough to settle rapidly in the gravity clarifier (64). Upon entering the gravity clarifier (64) the heavy solids settle to the bottom and exit the gravity clarifier (64) through a pipeline (66). Clarified water exits the gravity clarifier (64) through pipeline (65). Some of the magnetic biofloc settling out of the gravity clarifier (64) flowing through pipeline (66) is transferred by pump (77) back through a pipeline (78) and into the activated sludge basin (61) and is referred to as RAS. The remaining solids called WAS from pipeline (66) are pumped (67) through pipeline (68) and into an inline shear device (69). This inline shear device (69) shears the floc separating the magnetite from the non-magnetic solids. This sheared slurry flows to a magnetic drum (70) that collects the magnetite and returns it through a pipeline (72) to the magnetite mix tank (73). Non-magnetic material not adhering to the magnetic drum (70) exits through a pipeline (71) and is disposed.

FIG. 16b shows a MBC biological treatment system for comparison to the Biomag system shown in FIG. 16a. In the MBC biological treatment system shown in FIG. 5b, wastewater (60) flows into an activated sludge basin (61), where after biological treatment, biofloc is formed. Biofloc then flows out of the activated sludge basin (61) through a pipeline (79) where fresh magnetite (74), cleaned magnetite (72) and magnetic floc flowing through pipeline (78) called RAS from the gravity clarifier (64) are all combined together to form a magnetic floc with the aid of a flocculating polymer (63). The solids in the water are caused to floc together in pipeline (80) because of the energy provided by the turbulent flow of the water. The pipeline (80) is designed with certain inline features and devices that provide the necessary turbulence for efficient flocculation to form a magnetic floc. The magnetic floc that contains biosolids and magnetite then flow through a magnetic device (83) in the form of magnetic disks attached to a rotating shaft that collects the magnetic floc and raises the magnetic floc out of the water so it can be scraped off and flows into a mechanical shear device (82). This mechanical shear device (82) is a horizontal tube that contains a plurality of rotating shear disks that cause the magnetic floc to break apart into its magnetic and non-magnetic components. The shear disks are preferably made of abrasion and corrosion resistant plastic. This slurry of magnetic and non-magnetic solids then flows to another magnetic device (81). This magnetic device (81), preferably in the form of a drum that contains rare earth permanent magnets, collects the magnetite and the collected magnetite (72) is scraped off the magnetic device (81) causing the magnetite to flow back into the pipeline (80) where it is reused to combine with new biofloc from the activated sludge basin (61). Some magnetic floc is allowed to bypass (38) the magnetic device (83) through pipeline (62) and into the gravity clarifier (64). Upon entering the gravity clarifier (64) the heavy magnetic floc settles to the bottom and exits the clarifier (64) through a pipeline (66). Clarified water exits the clarifier through pipeline (65). Preferably a non-shearing pump (77) moves the magnetic floc in pipeline (66) through pipeline (78) back into the inline MBC system through pipeline (79). As the magnetic floc is pumped (77), the magnetic floc is sheared somewhat by the pumping action so a flocculating polymer (67) may be added to the pipeline (78) so the floc is reformed and any sheared non-magnetic biofloc particles are reattached to the magnetite. Non-magnetic solids that have been separated by the magnetic device (81) flow either through pipeline (84) back into the activated sludge basin as RAS or through a pipeline (71) as WAS, which is then disposed.

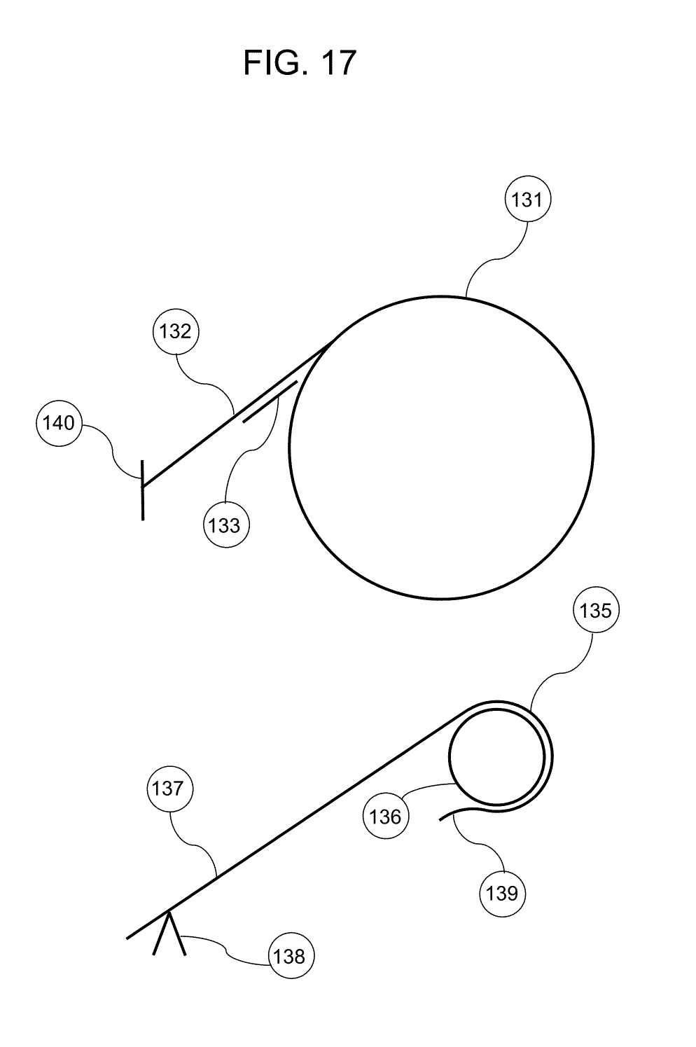

FIG. 17 shows two types of scrapers. The top view shows a scraper (132) affixed to a magnetic drum (131) that contains a ferromagnetic strip (133) that causes the scraper (132) to be attracted to the magnetic drum (131) by magnetic force. The scraper (132) is fixed at the point (140) furthest from the magnetic drum (131) to prevent the scraper from moving away from the magnetic drum (131) as it rotates. The bottom view shows a scraper (137) that is curved (135) in such a way that it circles the rotating shaft (136) so the scraper (137) will keep attached to the rotating shaft (136) when it rotates. A restraining device (138) keeps the scraper (137) from rotating with the rotating shaft (136). On one end of the scraper (137) is a curved section (139) that allows the scraper (137) to be easily snapped onto the rotating shaft (136).

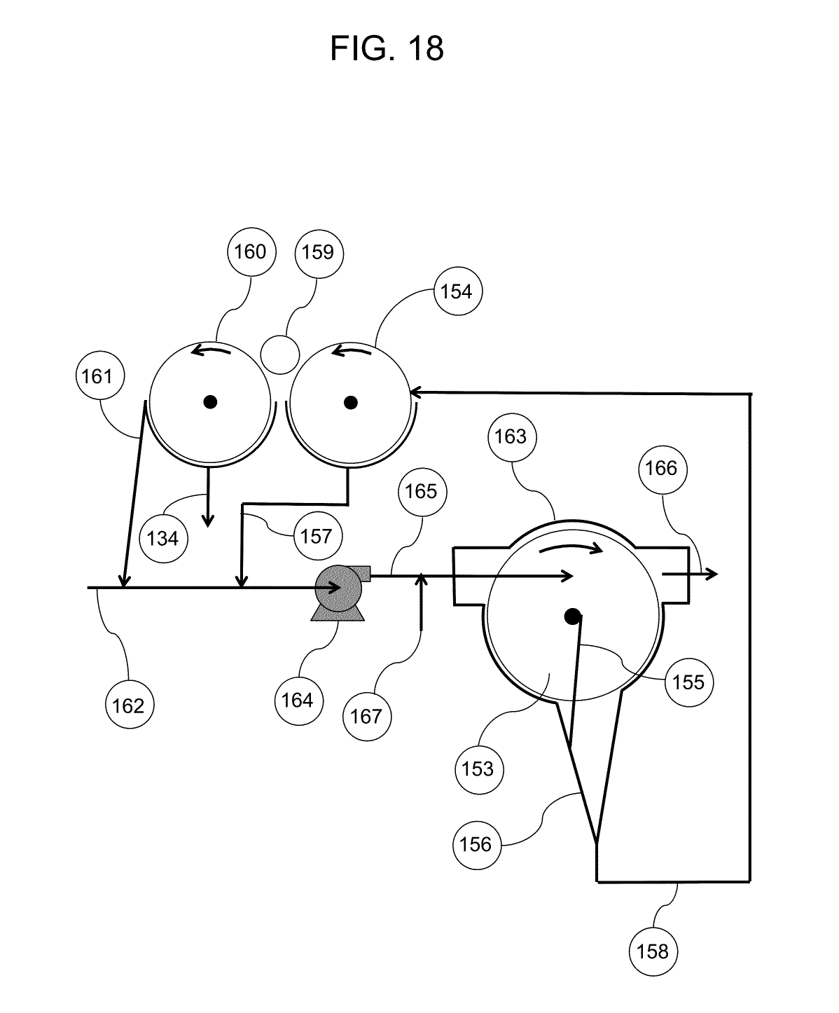

FIG. 18 shows a MBC that operates under pressure. Unclarified water (162) along with cleaned magnetite (161) and recycled water (157) is pumped (164) through a pipeline (165) where flocculating polymer (167) is added to form a magnetic floc inline. The magnetic floc then flows into a magnetic collector (163) that contains a plurality of rotating magnetic disks (153). As the magnetic disks (153) rotate, the magnetic floc that has adhered to the magnetic disks (153) contacts scrapers (155) that remove the magnetic floc from the magnetic disks causing the magnetic floc to fall into a collection cone (156) located below the magnetic collector (163). The pump (157) that moves the magnetic floc through the magnetic collector (163) produces enough pressure to cause the clarified water to flow (166) out of the magnetic collector (163) and enough pressure to cause magnetic floc to flow through a pipeline (158) to a magnetite cleaning system. The magnetite cleaning system is composed of a magnetic drum (154), a shear device (159) that separates magnetite from suspended solids, and a magnetic drum (160) that captures the magnetite to return to the system (161) and non-magnetic solids to discharge (167).

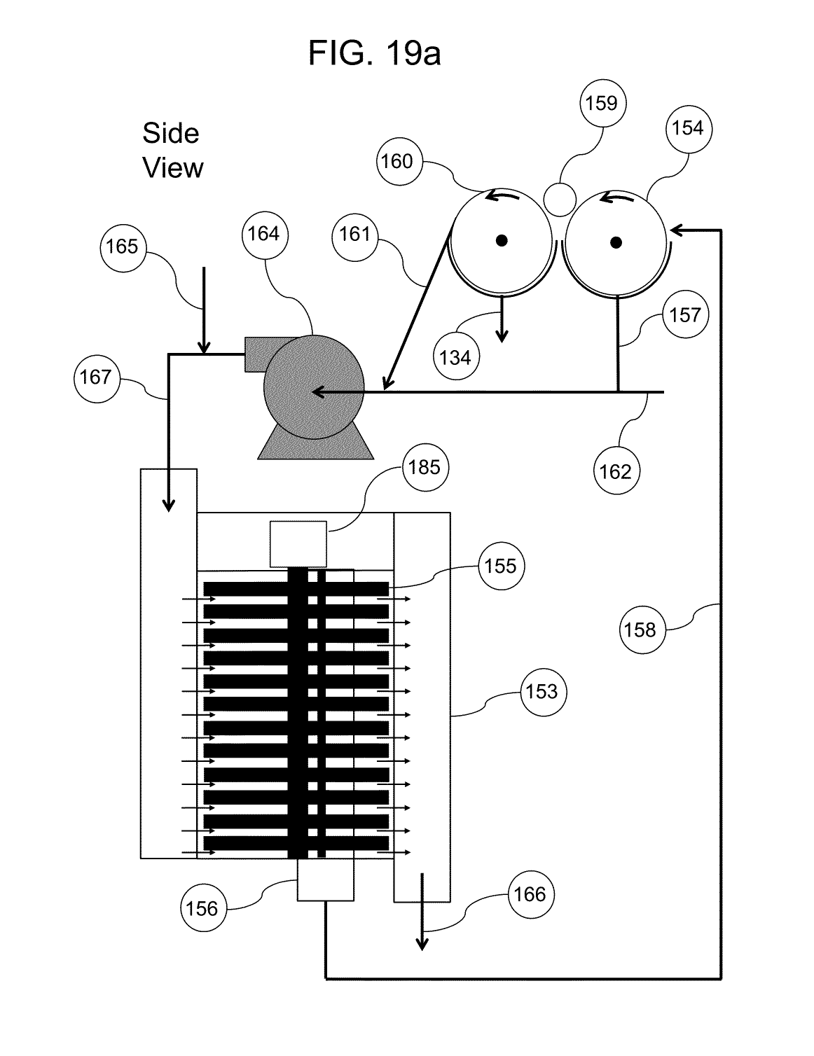

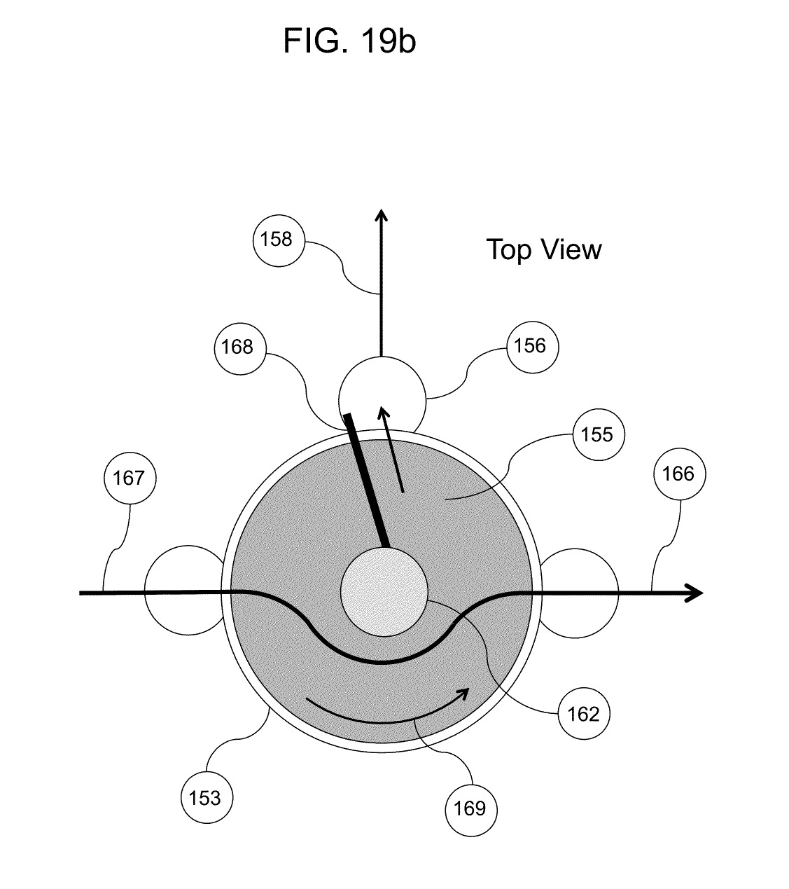

FIG. 19a shows the side view of a pressurized MBC with the final collector mounted in a vertical position. Unclarified water flows through a pipeline (162) and combines with cleaned magnetite (161) before entering a pump (164). At the discharge of the pump (164), flocculating polymer (165) is injected into the pipeline (167) and the flocculated solids flow into a vertical final magnetic collector (153). The flocculated solids adhere to magnetic disks (155) that are caused to rotate by a gearmotor (162). At the disks rotate, the magnetic floc affixed to the magnetic disks (155) is scraped off and discharged through a collector pipe (156) and flows through a pipeline (158) to a magnetite cleaning system. The magnetic floc is first dewatered on a magnetic drum (154) and the excess water flows back into the inlet pipeline (162). The dewatered magnetic floc flows to a shear device (158) that separates the magnetite from the suspended solids. The magnetite is collected on a magnetic drum (160) and then scraped off (161) back into the system. Non-magnetic solids that do not adhere to the magnetic drum (160) are discharged through a pipeline (134).

FIG. 19b shows the top view of the pressurized MBC shown in FIG. 19a with the final collector mounted in a vertical position. Water containing magnetic floc (167) flows into a magnetic collector (153) that contains magnetic disks (155) that are rotating in a counterclockwise direction (169) powered by a gearmotor (162). As the magnetic floc that has adhered to the magnetic disks (153) comes into contact with a scraper (168), the magnetic floc is scraped off and enters into a tube (156) and flows out through a pipeline (158) to be cleaned. Clarified water exists through a pipeline (166).

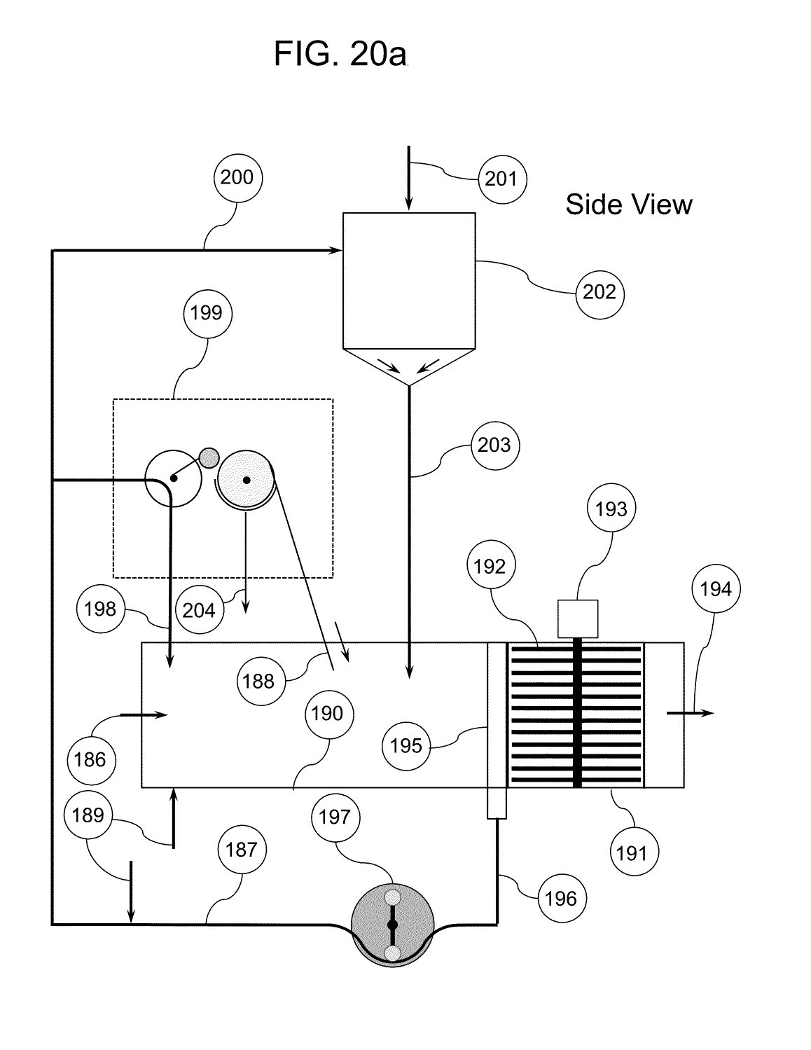

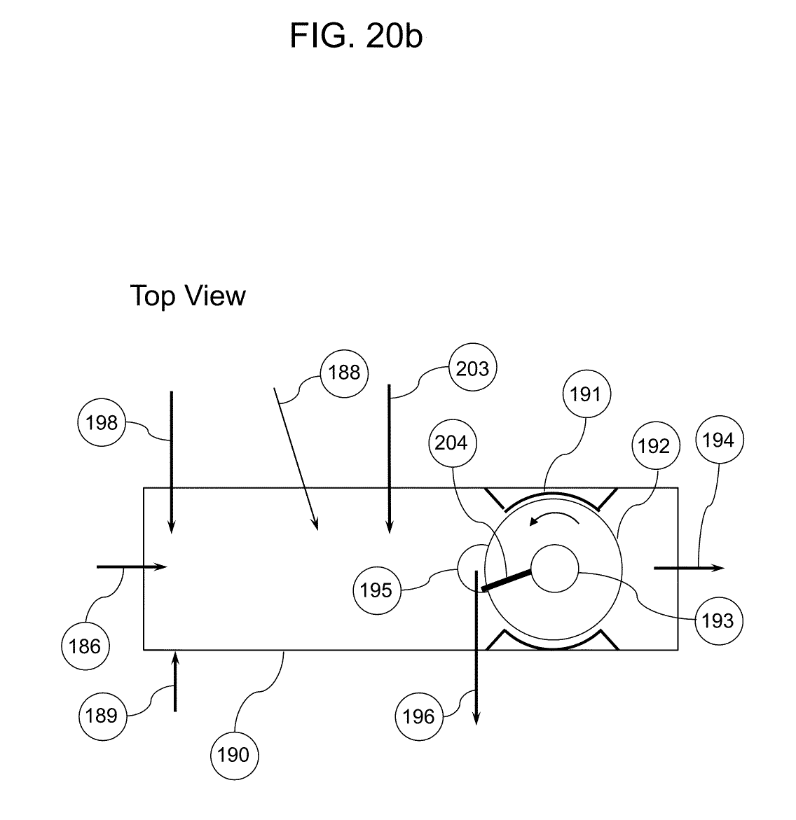

FIG. 20 shows how a MBC unit can be integrated with a vortex separator to remove fine suspended solids from storm water. Storm water flows through a pipeline (170) and into a vortex separator (171). Clarified water (172) exits the vortex separator (171) and magnetic floc (173) exits the bottom of the vortex separator (171) through a pipeline (174) and is pumped (175) through a pipeline (176) and into a magnetite cleaning system (183). Upon entering the magnetite cleaning system (183), the magnetic floc first passes through a magnetic collector (178), which collects the magnetic floc and passes it on to a shear tube (179) that shears the magnetic floc before it passes to another magnetic collector that separates clean magnetite (181) from the waste non-magnetic solids (182). Once the magnetic floc has been removed by the magnetic collector (178) the remaining water (177) flows back into the storm water. The magnetite is returned to the flowing stream of storm water (170) where with the use of a flocculating polymer it attaches to fine suspended solids contained in the storm water. The turbulence in the pipeline causes the magnetite (181) and the fine suspended solids contained in the storm water to floc together forming a magnetic floc that is heavy and readily settles in the vortex separator (171). This system can be applied to any water that requires clarification.

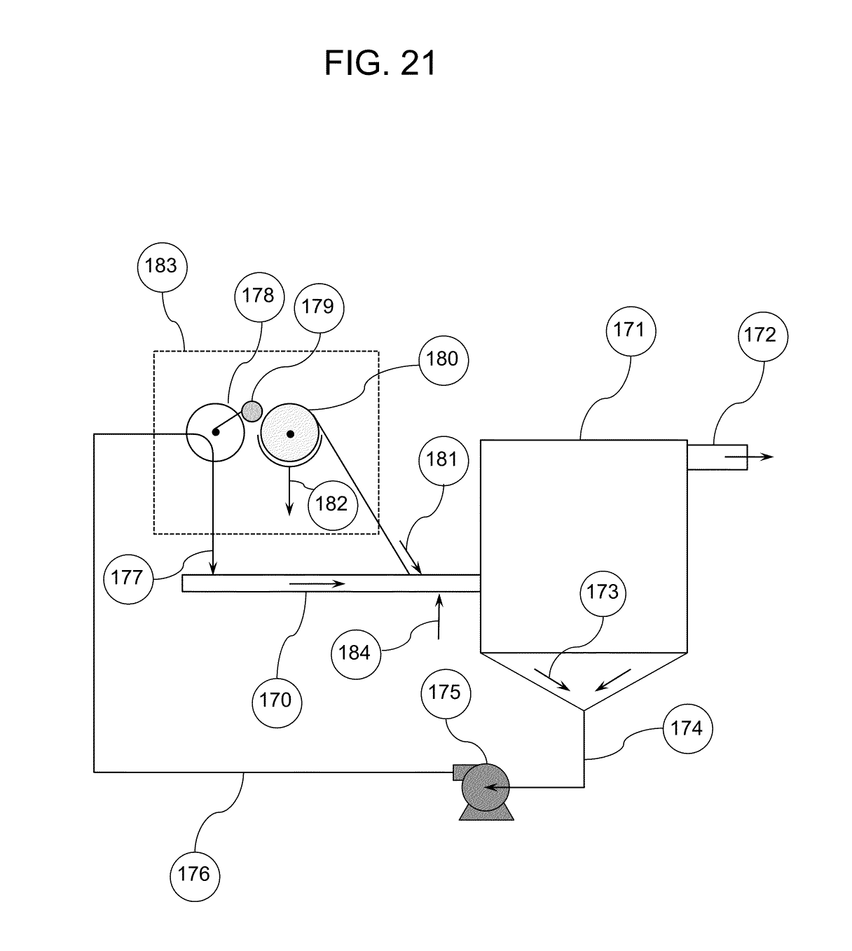

FIG. 21 a shows a side view of a complete MBC system with the details of a final magnetic collector that is mounted vertically in a flowing stream of water. Unclarified water (186) flows through a pipeline (190) and combines with water (198) from a magnetite cleaning system (199), cleaned magnetite (188) from this same magnetite cleaning system (199), fresh magnetite (201) and stored magnetite (202) contained in a magnetite storage tank (202) and flowing through pipeline (203). In pipeline (190), all of these components mix and with the combination of a flocculating polymer (189) form a magnetic floc. This magnetic floc then flows through a magnetic collector (191) that contains a plurality of magnetic disks mounted onto a vertical rotating shaft driven by a motor (193). As the disks rotate, the magnetic floc is scraped off the magnetic disks and discharges into a vertically mounted tube that contains an opening that allows the magnetic floc to flow out of the system through a pipeline (196) and through a low shear pump (197) that causes the magnetic floc to either flow through a pipeline (187) into the magnetite cleaning system (199) or to flow through a pipeline (200) into a magnetite storage tank (202).

FIG. 21b shows the top view details of the same pipeline (190) where flocculation occurs. This FIG. 13b shows the details of the final magnetic collector (191) mounted vertically inside the pipeline (190). The final magnetic collector (191) contains magnetic disks (192) mounted on a vertical shaft that is rotated by a drive motor (193). As the magnetic disks (192) rotate in this case in a countercurrent direction, the magnetite collected on a magnetic disk (192) comes into contact with a scraper (204) that is mounted to the rotating shaft and remains stationary in relation to the rotation of the magnetic disks (192). This causes the magnetic floc to move to the perimeter of the magnetic disk (192) causing the magnetic floc to fall into a vertically positioned collection tube (195) and out through a pipeline (196).

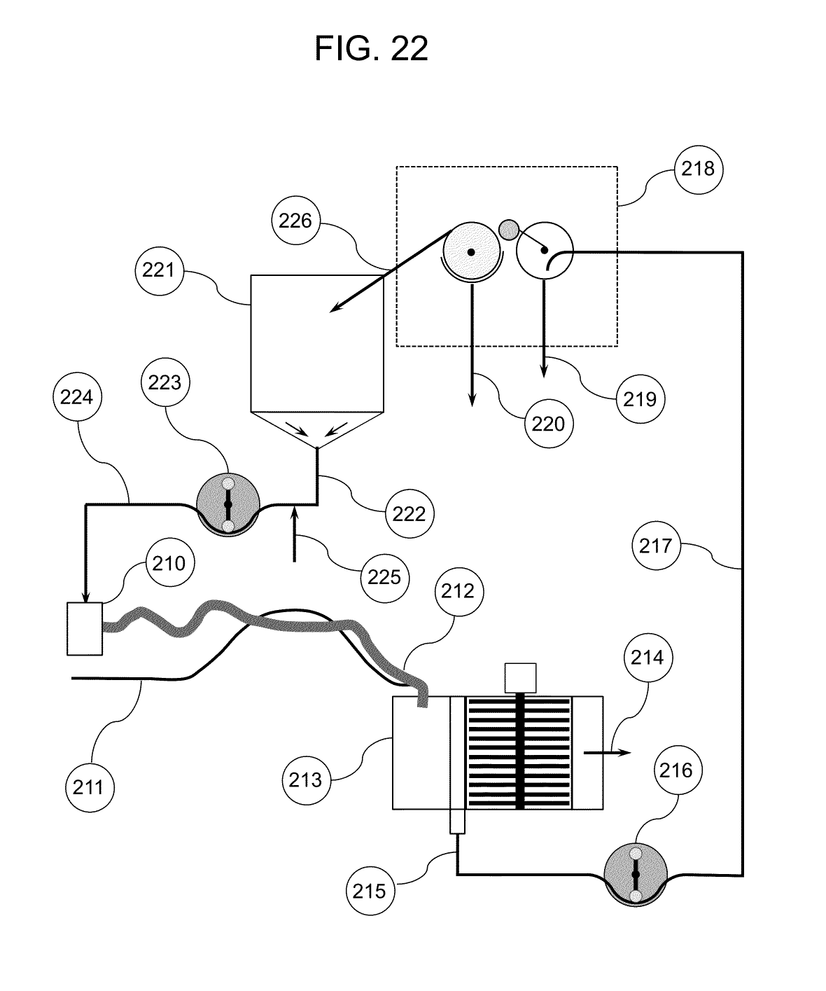

FIG. 22 shows the application of an inline MBC that is separated into its separate components to treat wastewater coming from a pond or lagoon. Water contained in a lagoon (211) flows into a floating suction (210) where it combines with magnetite (224) and flocculating polymer (225). The flocculating polymer (225) and magnetite (224) combine with the suspended solids contained in the water and with the energy provided by turbulent flow in the pipeline (212) a magnetic floc is formed. Then the magnetic floc flows into a magnetic collector (213). The magnetic collector (213) removes the magnetic floc from the water and clarified water is discharged through pipeline (214). The magnetic floc is scraped off the magnetic disks and flows out through pipeline (215) and is pumped (216) through pipeline (217) to a magnetite cleaning system (218). The magnetite cleaning system (218) first discharges clean water (219) back to the pond to reduce the amount of waste produced, then the magnetite cleaning system (218) separates cleaned magnetite (226) and discharges it into a storage tank (221) for future reuse. The magnetite cleaning system (218) also discharges waste (220) for disposal. Stored magnetite (226) is discharged from the storage tank (221) through a pipeline (222) and after flocculating polymer (225) is added, the products are pumped (223) through a pipeline (224) back into the MBC for reuse.

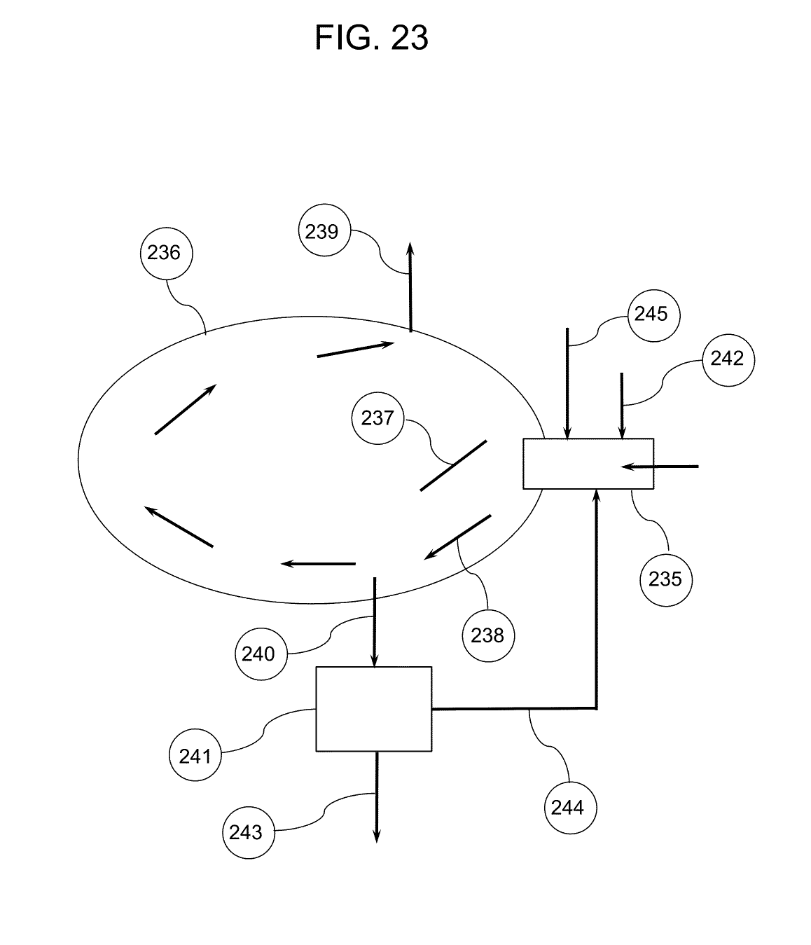

FIG. 23 shows storm water flowing through a conveyance (235) into an impoundment structure (236). While the storm water is flowing through the conveyance (235) it combines with magnetite (244), a flocculating polymer (242) and possibly a precipitating agent (245) and when enough energy is provided for by the flowing water through the conveyance (235) a magnetic floc is formed. This magnetic floc then comes into a flow directing device (237) that causes the water to flow in a pathway that is conducive to prevent short-circuiting through the impoundment structure (236) and deposits the settled magnetic floc in an area where it can be withdrawn from the impoundment structure (236) through a pipeline (240) and into a floc cleaning device (241). The floc-cleaning device (241) separates the magnetite that is returned to the conveyance (235) through a pipeline (244) for reuse. Waste from the floc-cleaning device (241) is disposed through a pipeline (243).

The invention claimed is:

1. A process for clarifying water in a flocculation tank that contains water, suspended solids, magnetic material, and flocculating polymer and such process for clarifying water is comprised of (1) a magnetic device that performs two processes comprising first the prevention of magnetic material and other attached solids from leaving the flocculation tank and second raises the magnetic material and attached solids out of water so they can be processed in a cleaning system and (2) a magnetic material cleaning system that makes it possible to separate magnetic material from non-magnetic material thereby allowing the cleaned magnetic material to be returned to the flocculation tank for reuse and the separated solids to be disposed of as waste.

2. The magnetic device of claim 1 is comprised of a plurality of partially submerged circular disks affixed to a horizontal rotating shaft.

3. Positioned between each circular disk of the magnetic device in claim 1 is a scraper preferably made of abrasion resistant plastic that by the rotation of the circular disk causes the magnetic material collected on each circular disk to rise out of the water and flow into a magnetic material cleaning system.

4. The plurality of circular disks of claim 2 are comprised of permanent magnets such as but not limited to rare earth magnets imbedded into nonmagnetic material such as but not limited to plastic materials or nonmagnetic metal materials thereby forming a magnetic circular disk.

5. The magnetic device of claim 1 is partially submerged inside the flocculation tank that contains water, suspended solids, and magnetic material and with the addition of a flocculating chemical, a magnetic floc is formed.

6. The water and magnetic floc flow through the magnetic device in claim 1 and the magnetic floc attaches to the permanent magnets contained inside the plurality of circular disks comprising the magnetic device.

7. The direction of water flowing between the pluralities of magnetic circular disks comprising the magnetic device in claim 2 is from the perimeter of the magnetic circular disks to the center of the magnetic circular disks.

8. Each magnetic circular disk of claim 7 has a center cutout so water flowing from the perimeter of the magnetic circular disk to its center can exit the plurality of the magnetic disks horizontally along the shaft rotating the magnetic circular disks and out of the flocculation tank.

9. An inline magnetic clarifier system that uses a flocculating polymer and magnetic material to remove suspended solids from water moving through a pipeline.

10. The inline magnetic clarifier system of claim 9 includes first a magnetic device preferably composed of a plurality of magnetic disks mounted vertically onto a horizontal rotating shaft, second a shear device preferably comprised of a hollow plastic tube containing shear blades, and finally a second magnetic device preferably comprised of a plastic drum containing permanent magnets mounted therein.

11. The first magnetic device of claim 10 is comprised of a plurality of magnetic disks and since they are not fully submerged their rotation raises the collected magnetic floc out of the water and by the action against the scrapers positioned between the magnetic disks, the magnetic floc separates from the magnetic disks so the magnetic material can be cleaned and reused.

12. The first magnetic device of claim 10 also prevents the flow of magnetic floc further down the pipeline thereby first performing a separation function and second raising the magnetic floc out of the water so the magnetic material can be cleaned and reused.

13. The shear device of claim 10 uses mechanical force to cause magnetic material to separate from attached non-magnetic suspended solids.

14. The second magnetic device of claim 10 recovers the magnetic material so it can be recovered and reused and allows the non-magnetic suspended solids to be disposed.

15. The inline magnetic clarifier system of claim 9 preferably can be installed in another treatment tank such as but not limited to an aeration basin to reduce footprint and to simplify piping arrangements thereby reducing cost and preventing magnetic material from flowing downstream into other water treatment devices.

16. A scraper that includes a ferromagnetic strip that causes the scraper to attract to a magnet device such as a magnetic drum and thereby the scraper adheres to the drum and is self-adjusting.

17. A process in claim 1 and in claim 9 that can be operated under pressure so there is no pressure loss in the clarification process.

18. The magnetic device in claim 17 is comprised of a pressure vessel containing a horizontal or vertical plurality of magnetic disks attached to a rotating shaft.

19. The magnetic disks in claim 17 have scrapers that remove magnetic material from the magnetic disks causing the magnetic material to flow out of the pressure vessel under pressure to a magnetic material cleaning device.
